(19) United States
(12) Patent Application Publication
(10) Pub. No.: US 2002/0065671 A1
(43) Pub. Date: May 30, 2002

(54) Method and system for project customized business to business development with indexed knowledge base

(76) Inventors: David J. Goerz JR., Menlo Park, CA (US); Cordell William Hull, Atherton, CA (US)

Correspondence Address: CARR & FERRELL LLP, 2225 EAST BAYSHORE ROAD, SUITE 200, PALO ALTO, CA, 94303, US

(21) Appl. No.: 09/774,447

(22) Filed: Jan. 30, 2001

Related U.S. Application Data
(63) Continuation-in-part of application No. 09/660,312, filed on Sep. 12, 2000.

(51) Int. Cl. G06F 17/60

(52) U.S. Cl. 705/1

(57) ABSTRACT

A method and system for implementing a project development workspace comprises a project development Website, a project, a project workspace, and a unidirectional data gate. The project development Website includes a multi-dimensional knowledge base. The project workspace is specific to the project and is associated with, but distinct from, the project development Website. The unidirectional data gate is for transferring data from the project development Website to the project workspace, without influencing the contents of the project development Website.

### CROSS-REFERENCE TO RELATED APPLICATIONS

This application is a Continuation-in-Part of U.S. patent application Ser. No. 09/660,312, filed Sep. 12, 2000, by David J. Goerz, Jr. and Cordell W. Hull, entitled, “Method and Apparatus for Business to Business Project Development with Indexed Knowledge Base,” which is hereby incorporated by reference.

### BACKGROUND OF THE INVENTION

1. Technical Field

The present invention relates generally to an Internet based Project Development System, and more specifically to a Project Customized Project Development System with an indexed and searchable database.

2. Discussion of the Prior Art

The Internet is a super network linking computer and server resources around the world, thereby allowing people to communicate and share information. Generally, this information is assembled and accessible on Websites identified with a specific Internet address. More Websites are introduced to the Internet everyday. These Websites include information covering a wide range of interests, topic, and needs. Accordingly, to be useful, users need tools to sort through this wide range of information, directing their visits to these Websites to those containing specific information.

Internet search engines such as Yahoo™, Google™, Excite™, SurfWax™, and Lycos™, among others, allow users to search for specific information, service, or resource. Typically, these Internet search engines are Websites that include an entry Web page with a form field to accept search terms, and are referred to as “browsers.” Typical browsers receive a “keyword” or “keywords” descriptive of the interest, topic, or need for which a user is seeking information or services. The browser's associated Website includes a database of URLs and URL information allowing it to search for any incident of the keyword(s), ultimately returning a list of URLs or Websites that may fulfill the user's needs. From here, the user must wade through the list of Websites, visiting each to determine which, if any, contain the desired information. Some browsers assist users by running various ranking algorithms, organizing Websites in a likely order of relevance. However, these browser Websites generally make no attempt to analyze the Website's actual content.

Also, most browsers make no attempt to discriminate between the needs of different types of users. For example, none of the above listed browsers discriminate between individual users and business users. The type of information sought by a project oriented business user is likely to be different from the type of information sought by an individual.

Further, the Internet is an increasingly important tool for businesses to promote their products and services. Likewise, the Internet is an increasingly important resource for business customers/users to find business resources. Business users need focused information in a fast and effective manner. A typical business user accesses the Internet to assemble project resources. A typical business project may require accessing many different types of resources including, but not limited to, materials, construction, financing, government codes and restrictions, regional information, country information, industry sector information, and other project specific supporting services The prior art method of assembling such a grouping of information, services, and resources is to use a traditional browser and search for information as needed on a resource by resource basis, cull through the list of URLs or Websites the browser identified, manually narrowing the search down to a useful set of resources. The problem with this method is that it is time consuming, frustrating, and wasteful. Business users often become frustrated with long lists of inapplicable Websites, giving up on their search after find one or two applicable Website resources. Giving up early is a problem because by accepting the first one or two applicable Website resources, a user may miss the “best” Website resources (i.e. the one the user would have found the most helpful, desirable, or interesting, for example). Another problem with this method of searching is that project oriented business users are limited to locating only one category of resource at a time. It would be more efficient, cost effective, faster, and convenient if a project oriented business user could access multiple project-oriented resources by running only one search.

The prior art includes such Internet resources as the resource that was located at www.ipanet.com. The ipanet.com Website recognized that business users have needs that may be different from the individual user, and provided resources including investment links, an events calendar, a document catalog, news sources and certain business summaries, generally directed to assisting business users. Although an improvement for business users, ipanet.com does not address the need for a project-oriented approach providing URL and other Internet resources to accomplish tasks at each phase of a project. The goal of ipanet.com appeared to be providing information about particular business-to-business resources focused on investments. The ipanet.com Website did not address the need for business-to-business users to assemble an entire project online and in a secure environment.

Another prior art method includes the invention described in U.S. Pat. No. 6,098,066, entitled Method and Apparatus for Searching for Documents Stored within a Document Directory Hierarchy. This invention addresses the need for efficiently storing and sorting information for rapid retrieval in a basic tree hierarchy. However, because the search categories themselves are linked to the directory structure, this invention does not address the need for connecting business users to Internet accessible business-to-business resources by locating URLs providing resource links.

Accordingly, the prior art does not address a business user's need for a project search tool that provides resources addressing multiple aspects of a project after running only one search.

Also, the prior art does not address the business user's need for providing online tools allowing online assembly of all of the resources needed to complete a business project.

Further, the prior art does not address the need for business-to-business users to assemble an entire project online and in a secure environment.

### SUMMARY OF THE INVENTION

The present invention sets forth a method and system for implementing a project development workspace that includes a project development Website, a project, a project workspace, and a unidirectional data gate. The project development Website has a multi-dimensional knowledge base. The project workspace is specific to the project and associated with, but distinct from, the project development Website and its multi-dimensional knowledge base. The unidirectional data gate is for transferring data from the project development Website to the project workspace, without influencing the contents of the project development Website.

The project workspace has a secondary knowledge base for housing information specific to the project. This secondary knowledge base may be initialized when project pertinent data is copied from the multi-dimensional knowledge base to the secondary knowledge base. Once initialized, the secondary knowledge base may be updated each time the multi-dimensional knowledge base is updated. This secondary knowledge base may be organized and indexed according to categories, where each category has a plurality of nodes, and each node is a URL. Further, the categories may be selected from a group of categories that include Life Cycle, Operating Region, Operating Country, Industry Sector, and Supporting Services.

### BRIEF DESCRIPTION OF THE DRAWINGS

FIG. 1 is a schematic block diagram of a system in accordance with an embodiment of the present invention;

FIGS. 2 and 2A are overviews of a system in accordance with an embodiment of the present invention;

FIGS. 3 and 3A are overviews of a system in accordance with an embodiment of the present invention;

FIG. 4 is an overview of a system in accordance with an embodiment of the present invention;

FIG. 5 is an overview of an embodiment of an Indexed Knowledge Base in accordance with an embodiment of the present invention;

FIG. 6 is an overview of a Super Category in accordance with an embodiment of the present invention;

FIG. 7 is an overview of a Super Category in accordance with an embodiment of the present invention;

FIG. 8 is an overview of a Super Category in accordance with an embodiment of the present invention;

FIG. 9 is an overview of a Super Category in accordance with an embodiment of the present invention;

FIG. 10 is a flow diagram in accordance with an embodiment of the present invention;

FIG. 11 is a flow diagram in accordance with an embodiment of the present invention;

FIG. 12 is an overview of a transaction in accordance with an embodiment of the present invention;

FIG. 13 shows a data vault for use in accordance with an embodiment of the present invention;

FIG. 14 shows a data vault for use in accordance with an embodiment of the present invention;

FIG. 15 is an overview of a transaction in accordance with an embodiment of the present invention;

FIG. 16 is an example of co-branding in accordance with an embodiment of the present invention;

FIG. 17 is a screen shot of an overview of a Website constructed in accordance with an embodiment of the present invention;

FIGS. 18A-M are screen shots of display screens of a feature implemented in an embodiment of the present invention;

FIGS. 19A-W are screen shots of display screens of a feature implemented in an embodiment of the present invention;

FIG. 20 is an overview of a project development workspace constructed in accordance with an embodiment of the present invention; and

FIG. 21 is a flow diagram of a project development workspace constructed in accordance with an embodiment of the present invention.

### DETAILED DESCRIPTION OF THE PREFERRED EMBODIMENTS

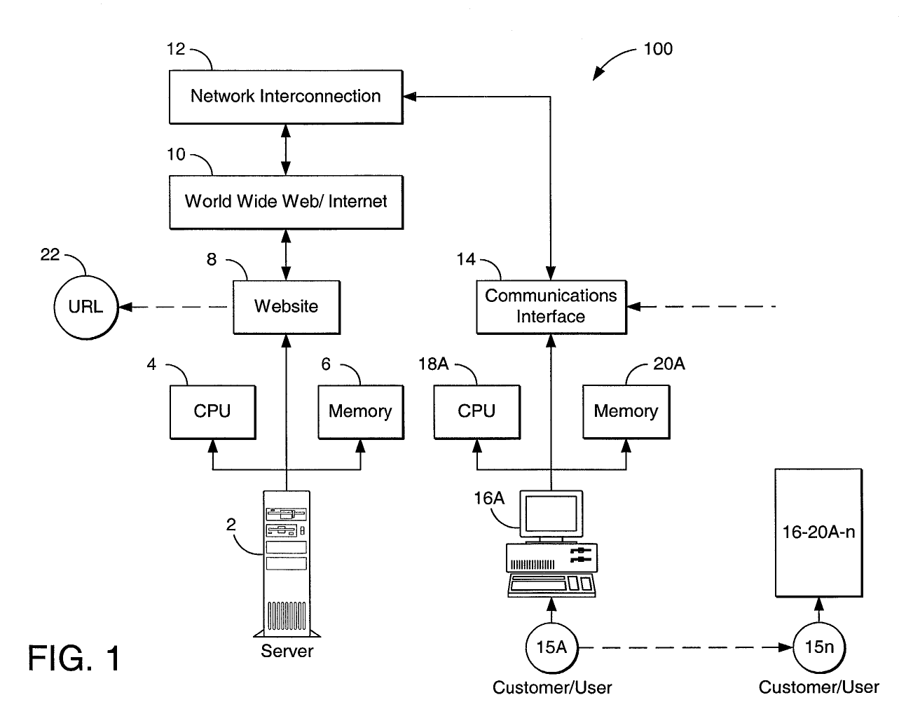

FIG. 1 schematically illustrates a project development system 100 in accordance with a preferred embodiment of the present invention. The project development system 100 includes a server 2, server central processing unit (CPU) 4, and server memory 6, where the server CPU 4 is for executing instructions in the server, and the server memory 6 is for storing and providing access to information, including but not limited to the Website 8. The server could be one of any of the plethora of servers known in the art capable of containing a CPU and suitable memory device(s) for housing an Internet Website, such as Website 8 in accordance with an embodiment of the present invention.

The project development system 100 also includes multiple customers/users 15A-n each having an Internet appliance 16A-n. (Element references citing a series of “A-n” elements represent a series of elements with an indeterminate number of elements “n” in the series, such that “n” is not intended to represent a specific number as denoted in the series “A-n.”) The Internet appliance includes an appliance CPU 18A-n, and an appliance memory 20A-n, where the appliance CPU could be any CPU capable of executing requested instructions, and the appliance memory could be any memory or memory device capable of providing an area for storing and retrieving information within the Internet appliance. The Internet appliance 16A-n could be any Internet appliance for interacting with an Internet Website, including but not limited to a computer, a laptop computer, a client server, a Palm Pilot™, an Internet terminal, an Internet kiosk, an interactive television, any device specialized in finding specific types of information, or the like.

In a further embodiment, instead of having an Internet appliance 16A-n with memory, the Internet appliance may have no memory and may directly project information onto a screen, terminal, or the like for viewing, or may alternatively print the information on a viewable medium, such as paper.

An Internet appliance 16A-n may have direct access to server 2, or may have access to server 2 through the World Wide Web/Internet 10, which could be the World Wide Web, or any other system connecting multiple users. For Internet appliances with no direct access to server 2, the project development system 100 further includes a communication interface 14 connecting the Internet appliance(s) 16A-n to a network interconnection 12, thereby providing access to the Internet 10. The communications interface 14 could be any interface known in the art including but not limited to a modem, an ISDN connection, a T1 line, a T3 line, a satellite link, a direct cable connection, or the like. The network interconnection 12 could be any network interconnection connecting the Internet appliance(s) 16A-n to the Internet 10, including but not limited to service providers such as CompuServe™, Earth Link™, Web TV™, America Online™, or any other service connecting a customer/user's Internet appliance to the Internet through a backbone telecommunications network, or other network. Ultimately, the project development system 100 allows Website 8 to link a customer/user's Internet appliance 16A-n to specially selected Uniform Resource Locators (URLs) 22 residing on other servers or Internet appliances accessed over the Internet, where each URL 22 is an Internet address to another Website.

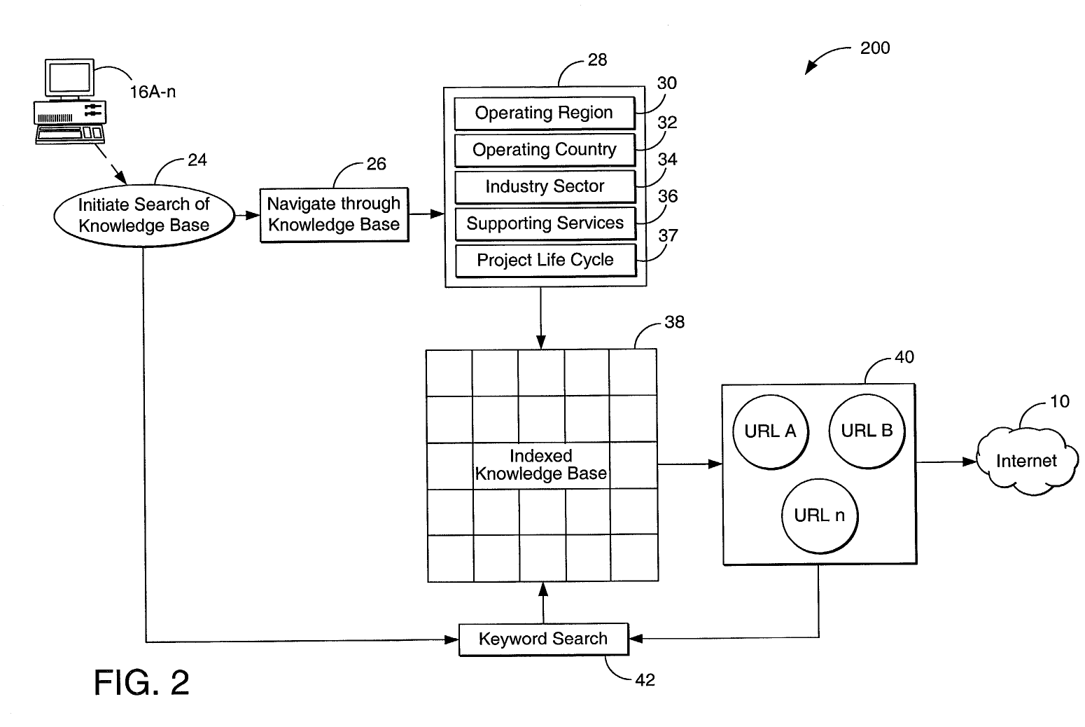

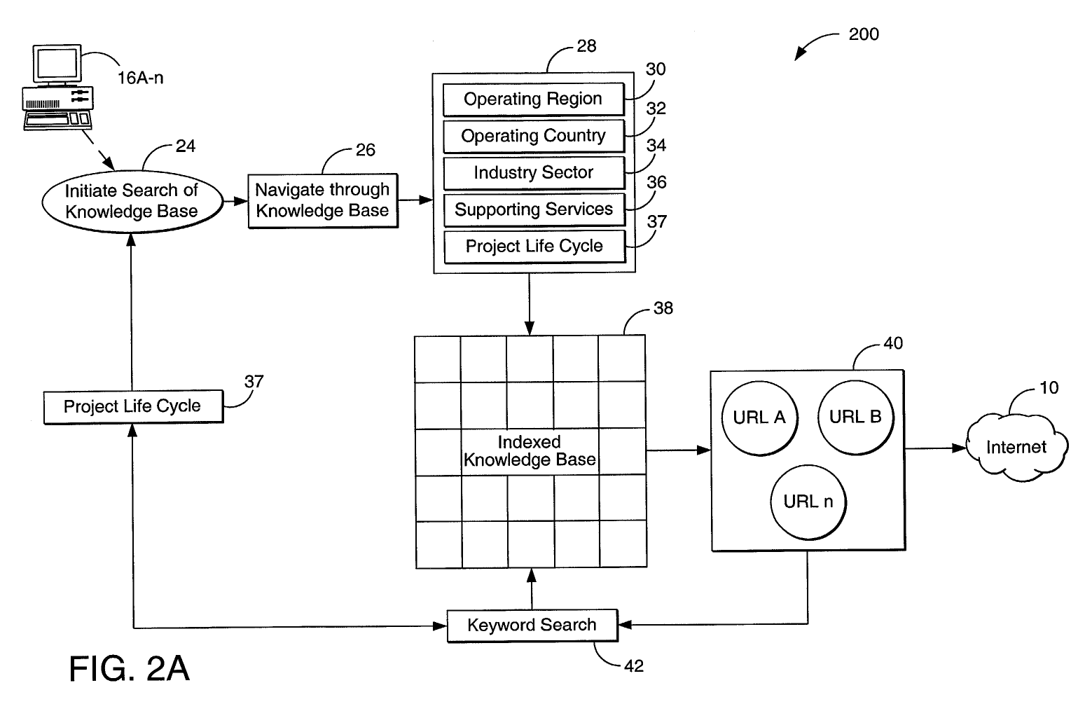

FIG. 2 is a Website overview showing system 200, which is constructed in accordance with an embodiment of the present invention. In this embodiment, Internet appliance(s) 16A-n send(s) an instruction 24 to initiate a search of indexed knowledge base 38. Indexed knowledge base 38 is a multi-dimensional database that may be constructed using any of a number of dimensions. Instruction 24 can be processed in at least two ways. First, instruction 24 can be processed as a request to navigate 26 through the indexed knowledge base 38. When instruction 24 is processed as a request to navigate 26, the customer/user 15A-n is launched into screen 28, which displays a group of predetermined navigable super categories The super categories are entry points into the indexed knowledge base 38, and may be dimensions of the indexed knowledge base.

A super category is a pre-determined category selected according to certain criteria that approximate the information according to a certain type of customer/user need. Such a super category could be determined by creating a well thought through market place directory, similar in idea to the yellow pages. In this case, a super category may include sub-categories and resources likely to fulfill the needs of a customer/user who initiates a search under a specific super category heading. As an illustrative example, super categories may include, but are not limited to, Operating Region 30, Operating Country 32, Industry Sector 34, Supporting Services 36, or Project Life Cycle 37. An advantage of navigating through a super category is that the sub-categories under that super category and the URL resources associated with that super category are well defined and conveniently sorted. In this way, the customer/user 15A-n is directed to a shorter list of the most pertinent resources.

Alternatively, in one embodiment of the invention, instruction 24 may be a request to do a keyword search 42. In this case, the request is processed as a traditional non-directed word search. While such a non-directed keyword search is less efficient than a navigated super category search, it allows the customer/user to create a search not otherwise defined in the pre-defined super categories, and is efficient in that it is limited to searching the specially selected URLs 40 included in the indexed knowledge base 38, rather than the entire universe of URLs available on the Internet.

In one embodiment of the invention, either a request to navigate 26 or a request to do a keyword search 42 will initiate a search of the indexed knowledge base 38. The indexed knowledge base is a multi-dimensional matrix of information, which is the core of Website 8 and is linked to tens of thousands of URLs. The result of such a search is a group of pertinent URLs 40. From this group of pertinent URLs, a customer/user 15A-n could select a URL and go to the Internet Website associated with that URL. The URLs in the group of pertinent URLs may include attributes such as an e-mail address, which may be used for business-to-business transactions.

In a further embodiment, when using a keyword search a directory string may be created and used to direct an Internet search on a traditional Internet web browser such as Yahoo™, Google™, Excite™, Lycos™, one allowing users to search according to a question input in natural language, such as Jeeves™, or the like, thereby returning a group of pertinent URLs 40 that may include URLs not otherwise in indexed knowledge base 38. Likewise, a search string could be delivered to a meta search engine such as Surfwax™, where a keyword search for a word or phrase could be made across any number of known Internet search engines, including but not limited to the above listed Internet web browsers.

Once a browser is selected for performing a keyword search, one skilled in the art would be familiar with a variety of search tools for improving a browser's natural language search abilities. Here, natural language is any language spoken by humans, as opposed to, for example, a programming or machine language. A natural language search may begin with a word or phrase describing the general nature of the information the customer/user 15A-n seeks. An extension of a natural language search could be a “fuzzy” search, which will locate Websites having information including words or phrases that are similar to the keyword(s). One skilled in the art would be familiar with techniques for accomplishing a fuzzy word search.

Search results may be refined using relevance ranking software, which ranks the relevance of each identified Website in a group of pertinent Websites 40. Relevance ranking software is well known in the art. Examples of browsers using relevance ranking software include, but are not limited to the above listed browsers. Also, known features such as Website summaries may be used to provide a snapshot of the information available on any Websites in the group of pertinent Websites 40. A snapshot summary is a short summary that may include the first several sentences of a Website's homepage, a sorted selection of words from a Website's collective pages, a specially edited statement, or the like. Most browsers, including those listed above, implement snapshot style summaries. For example, a customer/user may use this snapshot information to perform top level filtering of Websites in the group of pertinent Websites.

Further features may be combined and used to augment a browser's performance while executing a keyword search 42. For example, meta browsers such as Surfwax™ may provide a customer/user 15A-n with pattern-analysis technology incorporating algorithms for identifying customer/user use patterns. Pattern-analysis may be used to personalize a search thereby better analyzing customer/user needs and/or automatically assisting in appropriately narrowing a search. Also, browsers may provide customer/users with central server space for saving, storing, and sharing information. This type of space may be used, among other purposes, for storing selected Website documents in a personalized format, and/or for allowing customers/users to assign different documents different levels of security. Differing security assignments may allow customers/users to control who shares which documents/information. This type of storage feature is available, for example, on Surfwax™ when using the InfoCubby™ feature. Similarly, other augmenting tools may include, but are not limited to, a scalable information indexer such as SurfWalker™, available on Surfwax™, for processing Website information according to a user's preferences. Also available on Surfwax™ is SurfParker™, which is a tool that automatically adds, indexes, and includes new knowledge in a natural language searchable database.

Additional search strategies that may be employed in an embodiment of the invention include, but are not limited to accessing and searching Internet sites that return information with no URL addresses, such as information from the Internet “yellow pages.”

In one embodiment of the invention, URLs are included in the indexed knowledge base 38 after being reviewed by an editor. Editors determine which URLs and associated Websites include content appropriate for inclusion in the knowledge base. This review selection criterion eliminates irrelevant URLs that may contain keywords, but whose content is inappropriate or otherwise wrong for inclusion in indexed knowledge base 38. Other processes for selecting the indexed knowledge base's URLs may include a logical word search according to the selected super category and sub-category, a customer/user rating of URLs, or any combination thereof.

Each URL 22 included in the indexed knowledge base 38 is referred to as an “asset,” has specific attributes, and may contain information germane to a customer/user's interests, may direct a customer/user to a resource or service he or she may need for assembling/completing a project, or may be such a service itself.

In one embodiment of the invention, each URL 22 included in indexed knowledge base 38 is called a “node.” Each node is a location within the knowledge base and may be arrived at from any one of several searches. For example, the same URL 22 may be included in the group of pertinent URLs 40 where the search starts from either the super category of Operating Region 30 or Operating Country 32. Such an example is the URL associated with the Website for Standard General Bank, which is a bank having branches in several countries but whose home base is in the United Kingdom. In that case, a search including information related to financial institutions would return the URL for Standard General Bank for a first search under the super category of Operating Region, where the operating region was the United Kingdom. Similarly, a second search under Operating Country would return the same URL, where the operating country was a country having a Standard General Bank branch office. A URL's attributes are its properties or characteristics and could include such things as its name, industry specific information, country information, regional information, supporting services information, printer information, customer/user account information, password information, Internet accessible information, or the like.

In one embodiment, the URLs included in the indexed knowledge base are permanent nodes in that they may not be dynamically removed without editor intervention. Also, editors update and add URLs to the knowledge base. A customer/user's Internet appliance 16A-n may contain information in memory 20A-n including a partial or entire list of the URLs in the indexed knowledge base 38. In such a case, the information on the customer/user's Internet appliance may be updated each time he or she logs onto Website 8, where the update reflects any changes in the indexed knowledge base's contents.

To further illustrate this example, the partial or entire list of URLs stored in memory 20A-n may be a project development workspace. Such a project development workspace may be a customized workspace for developing a particular project according to that project's unique needs. The project development workspace may be initialized with Website 8 URLs representing resources that are likely to be pertinent to the project. The project development workspace may be customized with resources not available on Website 8. If customized, these customized resources would be available to the project, but would not be added to Website 8. Once the project development workspace is initialized and/or customized, it may continue to access Website 8 for new information, URLs, or resource, and it may be updated as new information, URLs, or resources as are added to Website 8. This updating may occur at regular intervals, upon a specific event, or on demand, for example.

As an illustrative example of using an embodiment of the invention described in FIG. 2, a navigable search identifying a specific super category such as Industry Sector 34 may direct a customer/user 15A-n to a group of pertinent URLs 40, which include URL 22. Similarly, a keyword search for a word(s) used in a particular industry may direct a customer/user to a different group of pertinent URLs that also include the same URL 22. The difference in search modes is that the navigation process directs the search according to super categories and sub-categories that have been pre-selected, analyzed, and grouped at the Website's server 2. By applying these selection criteria, the number of relevant URLs in any group of pertinent URLs 40 is reduced to a shortened list, thereby minimizing the time and effort customers/users 15A-n need to put into researching and analyzing information and resources. Conversely, keyword searches generally produce larger groups of potentially pertinent URLs, requiring the customer/user to spend more time researching and analyzing the individual URLs than if they had performed a search by super category navigation.

In one embodiment, after performing a navigable or a keyword search, a group of pertinent URLs 40 is returned. The group of pertinent URLs may be further narrowed by performing an additional keyword search using the group of pertinent URLs as the population of URLs to narrow from.

In one embodiment of the invention, a customer/user 15A-n must have a “key” to access Website 8. A key may be an identifier for identifying that customer/user to his or her account on Website 8. Such a key may include, but is not limited to, a name, a string of numbers, a specific sequence, a code, a credit card number, a social security number, any combination thereof, or the like. Also, a key may be implemented for restricting a customer/user's Website 8 access to less than all of the pages, resources, information, or the like on the Website. Further, a key may be implemented for restricting a customer/user's access to a project development workspace established for a particular project.

FIG. 2A is a Website overview showing an alternate embodiment of system 200. In this embodiment of system 200, a customer/user 15A-n may elect a route to navigate through knowledge base 26 as above described. In doing so, he or she may select any of the proffered navigable super categories displayed on a screen 28. Alternatively, the customer/user may choose to perform a keyword search 42. In this embodiment, a keyword search may be made after navigating through the super category of Project Life Cycle 37. In its broadest terms, a Project Life Cycle is a comprehensive management system for managing the process of completing a project. A Project Life Cycle has different phases, each requiring a different set of resources. Instituting a Project Life Cycle phase before a keyword search ensures that the URLs returned in the group of pertinent URLs 40 will be relevant to the project and to the specified phase of the project. Alternatively, the customer/user 15A-n may be offered a choice of where to do a keyword search, if at all, and a choice whether to limit the keyword search the URL's 22 in the group of URLs 40 or to search the entire Internet.

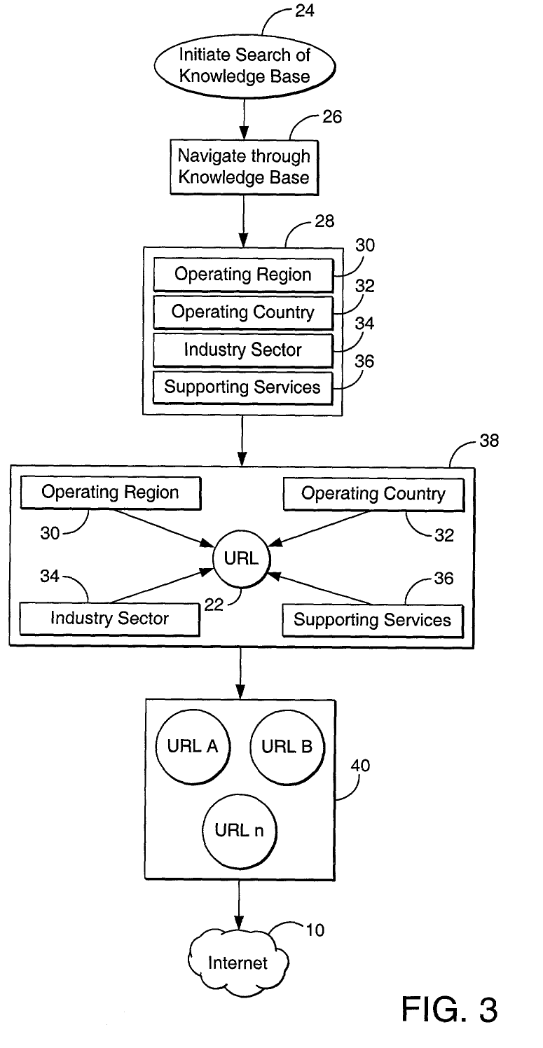

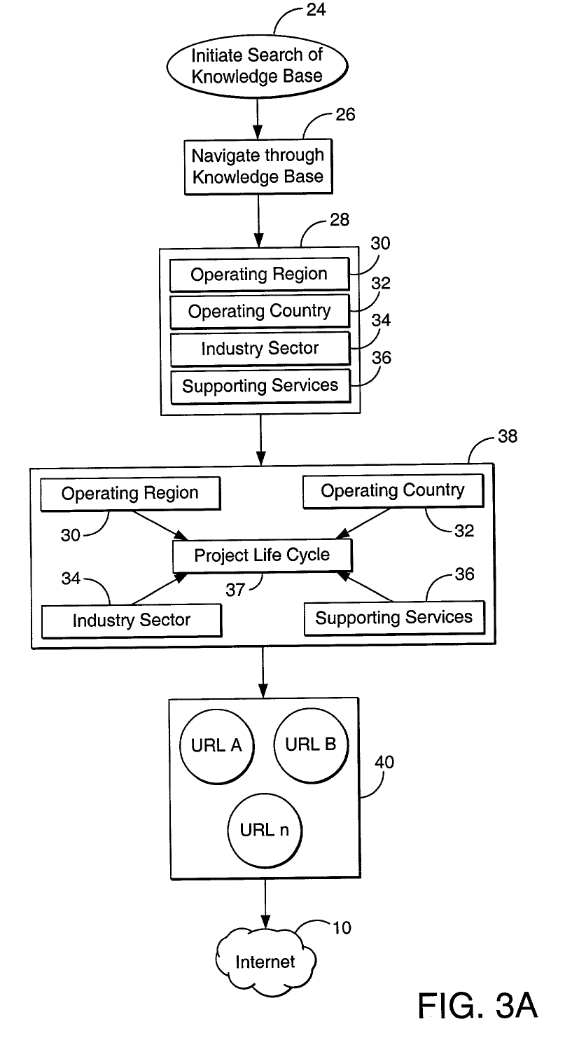

FIG. 3 describes an embodiment wherein instruction 24 initiates a search of the knowledge base, and request 26 subsequently requests a navigated search of the knowledge base. Here, the customer/user 15A-n is presented with a list of predetermined navigable super categories 28. After selecting a category, the customer/user narrows a search by drilling down through that super category arriving at specific URLs 22 These specific URLs are then included in the group of pertinent URLs 40.

In one embodiment of the invention, the group of pertinent URLs is continuously updated when new and pertinent URLs are added to indexed knowledge base 38. A customer/user 15A-n may use this group of pertinent URLs 40 as a connection to the business-to-business marketplace, launching directly to one of the listed URL's Websites, or may engage in a business-to-business transaction by communicating via e-mail where one of the attributes of a listed URL 22 is an e-mail address. Similarly, URLs connected to corporate or business Websites may be linked to that business in such a way that transactions may be processed directly and in real-time.

FIG. 3 further shows that in a navigated search, regardless of the selected super category, the same URL 22 may be identified and included in the group of pertinent URLs 40.

FIG. 3A is an alternate embodiment of the system depicted in FIG. 3, and described above. The system of FIG. 3A differs from that of FIG. 3 in that the resulting group of pertinent URLs from a navigated search of a super category selected from screen 28 are further refined by processing them through Project Life Cycle 37. In this way, the group of pertinent URLs 40 is project specific in both Project Life Cycle phase and selected super category.

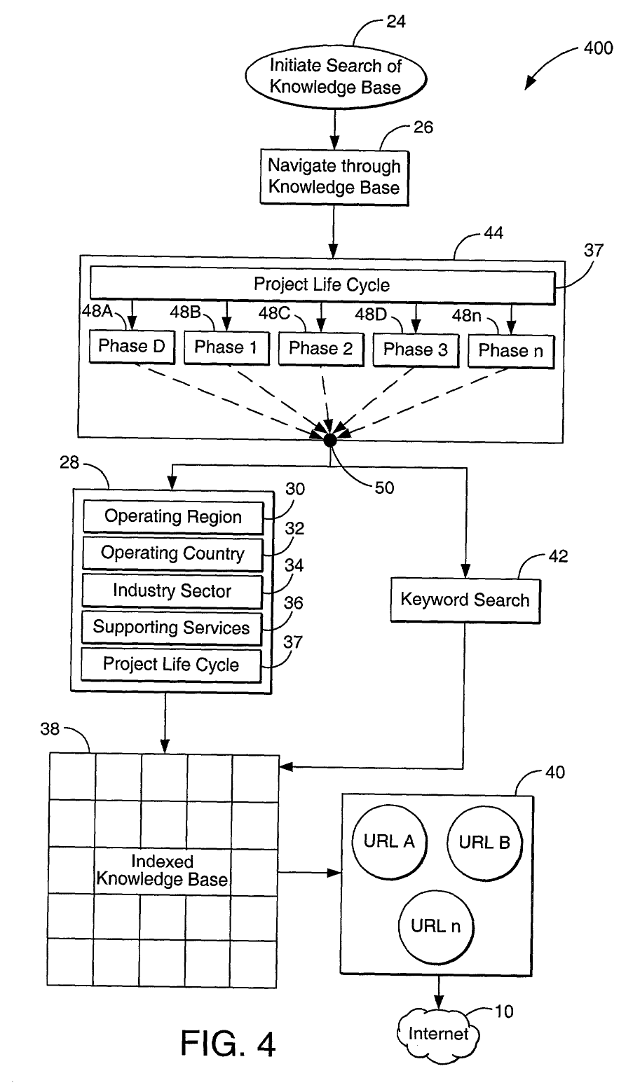

FIG. 4 describes an embodiment where instruction 24 initiates a search of the indexed knowledge base, and navigation step 26 subsequently initiates a navigated search of the knowledge base that is first directed to Life Cycle module 44. Life Cycle module 44 contains a specialized super category process such as Project Life Cycle 37, which may be processed in either a linear or parallel fashion, and is conducted in phases. For example, Phase 0, 48A, could be a concept phase, Phase 1, 48B, could be a feasibility phase, Phase 2, 48C, could be a definitive planning phase, Phase 3, 48D, could be a project structuring phase, and so on. In such an arrangement, URLs may be eliminated, or conversely included, in any subsequent search of the indexed knowledge base. This phase limiting of available knowledge base URLs creates a phase limited knowledge base 50, thereby providing the basis for subsequent searches. The search following the creation of the phase limited knowledge base may be made by selecting either a super category from the navigable group of super categories 28, or by performing a keyword search 42. The phase-limited knowledge base ensures that all URLs included in the group of pertinent URLs 40 pertain to the specified Life Cycle phase of the customer/user's 15A-n project. This process could be executed from Website 8, or from a project development workspace, which could be located with Website 8, on server 2 in memory 6, or in a location on the customer/user's Internet appliance 16A-n in memory 20A-n.

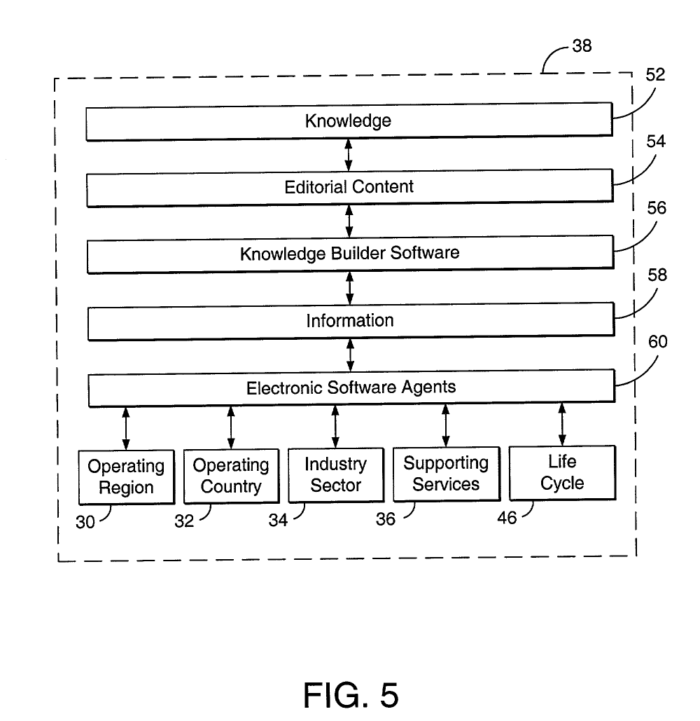

FIG. 5 is an overview of an embodiment of an indexed knowledge base 38 in accordance with an embodiment of the present invention. In one embodiment of the invention, the indexed knowledge base 38 is built using a process that moves through several data and processing layers. The first layer is knowledge layer 52. “Knowledge” is the dynamic organization of nodes contained in the indexed knowledge base 38, where the significance of a particular node may change according to incremental experiences or associations with a Website and its associated URL. Knowledge layer 52 incorporates all of the nodes included in the indexed knowledge base, along with information about each node. For example, knowledge layer 52 may further include a tag to each URL and its associated node, as well as information about each URL's attributes. These nodes may be arrived at by any search method; e.g. navigation, keyword, or the like.

Next, the editorial content layer 54 contains information that may be input by any person interfacing with the indexed knowledge base 38, such as an editor or customer/user 15A-n. Among other things, the information in the editorial content layer 54 may be used to rank, accentuate, comment on, or eliminate certain URLs from inclusion in a group of pertinent URLs 40, resulting from a navigated or keyword search.

Knowledge builder software level 56 is the level that includes the software for transforming the information provided at any level into “knowledge.” For example, the knowledge builder software layer 56 may be used to tie the information gathered in the editorial content layer 54 to the knowledge layer 52, thereby effecting a change in the results of a search of the indexed knowledge base 38. The knowledge builder software level 56 may be written in any language or script suitable for execution or implementation on a Website, such as C, C+, C++, Basic, Visual Basic, Java, or Java script.

Information layer 58 is the level that includes experiential information about URLs associated with the individual nodes in the indexed knowledge base 38. This experiential information may include, but is not limited to, the number of customer/user 15A-n selections of a particular URL, the size of a URL's associated Website, the number of electronic assets associated with a URL's Website, the average amount of time spent on a particular URL's associated Website, or the like. This information is gathered in information layer 58 and may be used, for example, to rank a URL as against other URLs in a group of pertinent URLs 40.

Electronic software agent layer 60 is the layer containing the software for identifying Internet URLs that may be suitable for inclusion in indexed knowledge base 38. As indexed knowledge base 38 expands and develops, a series of software agents may be employed.

In one embodiment, the electronic software agent recommends URLs for inclusion in indexed knowledge base 38. In doing so, the software agent also provides the editors with a human readable description of the recommended URL's Website, categorizing and sub-categorizing the URLs; e.g. Operating Region, Operating Country, Industry Sector, Supporting Services, Project Lifecycle, etc. The software agent may be further used to develop or assist in developing a description and list of searchable keywords for inclusion in the indexed knowledge base Multiple software agents may be used for assisting editors with expanding the knowledge base's content as to reflect the number and content of URLs. Software agents may also be used to remove duplicate URLs, dead links, defective links, and the like. Multiple software agents may be combined into an Internet enabled content management tool, which may be used in conjunction with indexed knowledge base 38 for selecting specific ranges of URLs for use with certain business-to-business transactions. These specific ranges of URLs may include URLs whose associated Websites have certain attributes such as, but not limited to, providing a searchable catalog, having customizable forms, allowing a request for receipt, allowing a request for purchase, any combination of these features, or the like. Like knowledge builder software layer 56, the software used to create the electronic software agent(s) in electronic software agent layer 60 may be written in any language or script suitable for execution on a Website.

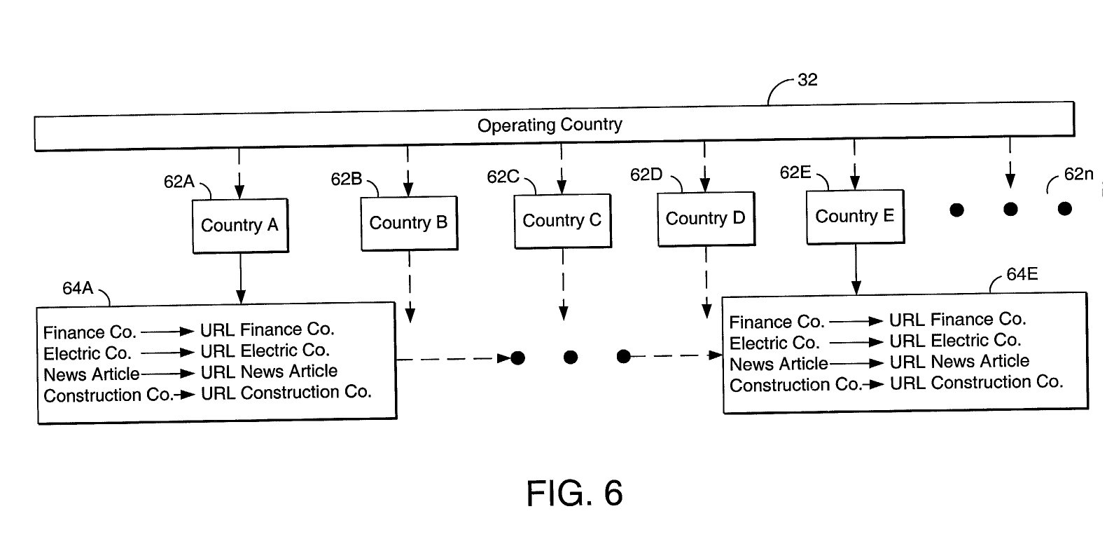

FIG. 6 is an overview of the super category relating to Operating Country 32, which is one of the dimensions of indexed knowledge base 38. In this embodiment, Operating Country 32 has a first sub-category 62A-n that provides a navigated search for project related information about different countries. For example, the customer/user 15A-n could search for URLs 22 relating to any number of countries 62A-n, including but not limited to, the United States, Japan, Uganda, England, Germany, Singapore, and the like, A further refined sub-category includes project related resources for a particular project in that country. For example, assuming Japan is Country A 62A, a navigated search requesting project related information for an electric power plant in Japan may return a group of pertinent URLs 40 that include the Internet resources and links 64A for a finance company, an existing electric company, recent news articles related to electric power plants, and a construction company that engages in large scale constructions such as electric power plants, among others.

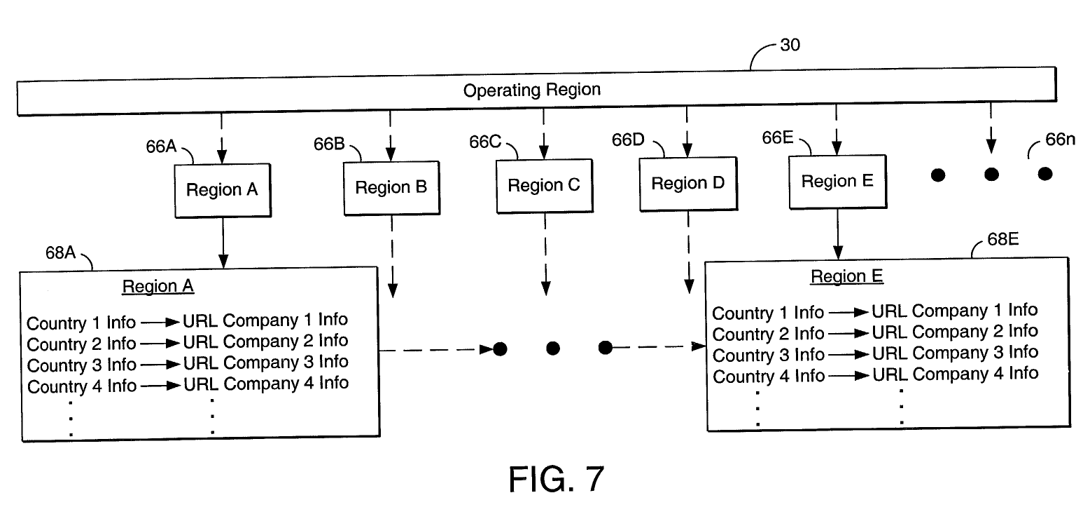

FIG. 7 is similar to FIG. 6, and is an overview of the super category relating to Operating Region 30, which is another dimension of indexed knowledge base 38. In this embodiment, Operating Region 30 has sub-categories 66A-n providing a navigated search for project related information about different regions. For example, the customer/user 15A-n could search for URLs relating to any number of regions 66A-n, including but not limited to, Asia, North America, South America, Africa, Europe, and the like. A further refined sub-category of the super category Operating Region 30 includes project related resources for a particular project in that region. For example, assuming Asia is Region A 66A, a navigated search requesting project related information for an electric power plant in Asia may return a group of pertinent URLs 40 that include Internet resources and links 68A with country information for Japan, India, China, Thailand, and Singapore, among others.

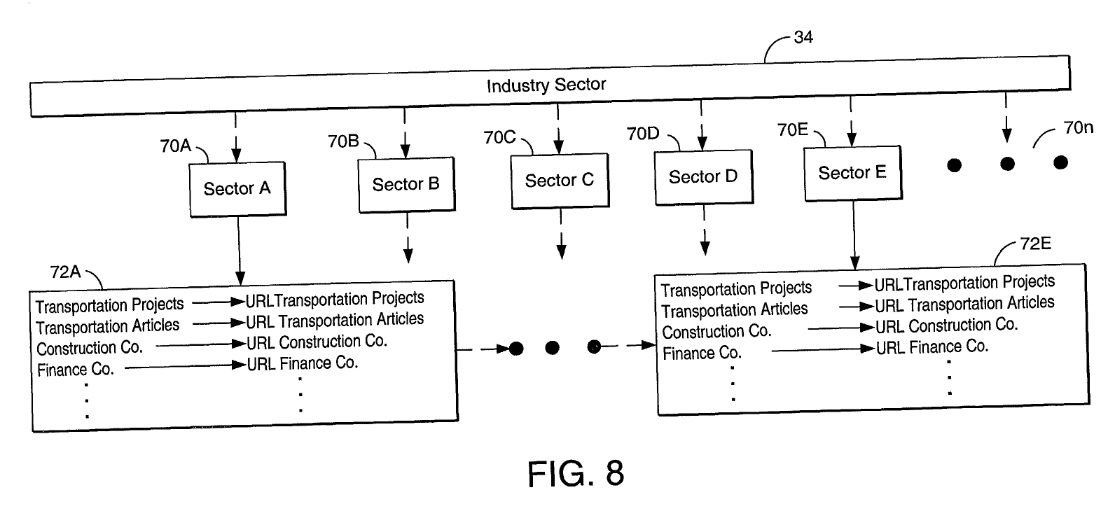

FIG. 8 is an overview of the super category relating to Industry Sector 34, which has a sub-categories 70A-n for providing a navigated search of URLs relating to different industry sectors. For example, the customer/user 15A-n could search for project related information on any of a number of industry sectors 66A-n, including but not limited to, electric power, energy, medical, infrastructure, telecommunications, and the like. Similar to the further refined navigations of FIGS. 6 and 7, further refined sub-categories of the super category Industry Sector 34 include project related resources for a particular project in an industry sector. For example, assuming Sector A 70A is electric power plants, a navigated search requesting project related information for an electric power plant may return a group of pertinent URLs 40 that include Internet resources with links 72A for electric power projects, electric power articles, construction companies specializing in large scale constructions such as electric power plants, and finance companies that finance large scale constructions such electric power projects, among others.

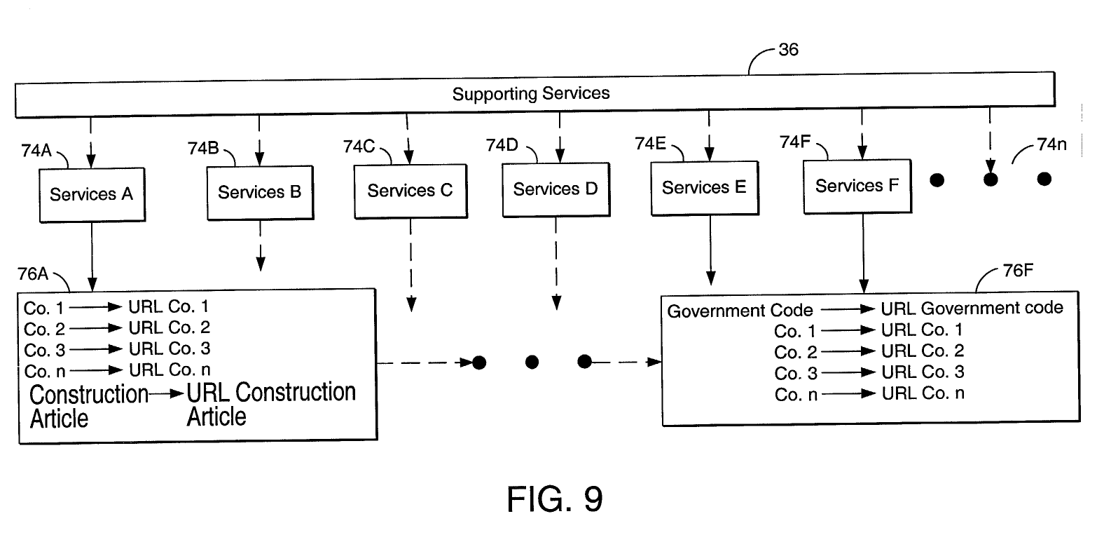

FIG. 9 is an overview of the super category Supporting Services 36, which has sub-categories 74A-n for providing a navigated search for project related information about different supporting services. For example, the customer/user 15A-n could search for URLs relating to any number of supporting services, including but not limited to, construction companies, ministries and agencies, finance, culture, geo political situation, tax, and the like Further refined sub-categories of the super category Supporting Services 36 include project related resources for particular projects. For example, a navigated search requesting information about construction companies may return a group of pertinent URLs 40 that include Internet resources and links 76A for several construction companies, and current articles about construction companies, among others. As another example, a navigated search requesting information about taxation may return a group of pertinent URLs 40 that include Internet resources and links 76F for various tax codes, companies providing taxation services, and recent articles discussing topics related to taxation, among others.

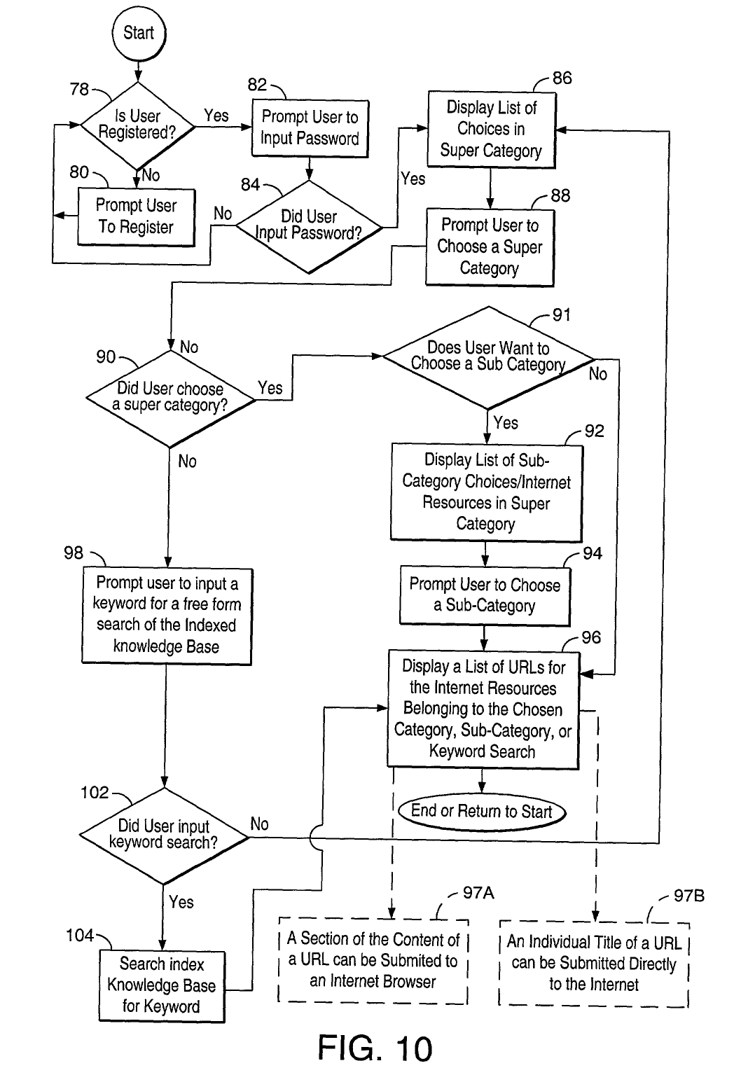

FIG. 10 is a flow diagram further illustrating an embodiment of the invention. In this embodiment, once a customer/user 15A-n enters Website 8, the process for using the Website is started and the customer/user is asked whether they are a registered user 78. If the customer/user answers “no,” he or she is prompted to register 80. Registration on Website 8 may allow a customer/user to be a registered user who may enter the Website and use its services, or who receives additional services such as, but not limited to, access to information or services not provided to non-registered users, regular e-mail updates about the Website, discounts at Websites associated with URLs included in the indexed knowledge base 38, a personalized page for easy transactions, such as a project development workspace for easy transactions, access to best practice manuals for each stage of the Website 8 processes, access to secure transaction space, alternative security processing, online collaboration or communication with service providers, or the like. One skilled in the art would be familiar with techniques for registering users including but not limited to setting a cookie, filling out a questionnaire, selecting a user name and password, inputting a credit card number, a combination of any of these methods, or the like.

Following registration step 80, the customer/user 15A-n is returned to step 78 and again asked whether they are a registered user. If the customer answers “no,” he or she will be returned to step 80 and prompted to register. If the customer/user answers “yes,” he or she is prompted to input a password 82. If no password is detected 84, the customer/user is returned to step 78, and the process begins anew.

If a password was entered 84, the customer/user's Internet appliance 15A-n displays a list of super category choices 86. The customer/user is prompted to choose a super category 88 from the list of super categories. If a super category is chosen 90, the user is asked whether he or she wants to choose a sub-category 91. If the user answers “no” a list of URLs for the Internet resources belonging to the chosen super category are displayed 96. If the user answer “yes,” a list of sub-category choices in the selected super category is displayed 92. The customer/user is prompted to chose a sub-category 94. A list of URLs belonging to the chosen super category, sub-category, or keyword search 96 is then displayed.

Referring back to step 90, if the user did not select a super category, the process presumes the user wanted to do a keyword search, and the user is prompted to input a keyword for a free form search of the indexed knowledge base 98. From here, if the user inputs a keyword 102, the knowledge base is searched 104, and a list of URLs for the resources belonging to the selected keyword are displayed, 96, on the customer/user's Internet appliance. However, if the user did not input a keyword 102 for a keyword search, the user is redirected to step 86 where the customer/user is presented with a list of super category choices, and the process begins anew from this point.

Once a customer/user reaches step 96 where a list of pertinent Internet resources is displayed, he or she may use the URL information to do any of a number of things including submitting a section of the content of a URL to an Internet Browser 97A for a search of further related sites. Similarly, an individual title of one of the URLs may be submitted directly to the Internet for a launch to that Internet Website 97B. Or, alternatively, a customer/user may choose to start the process again by returning to start.

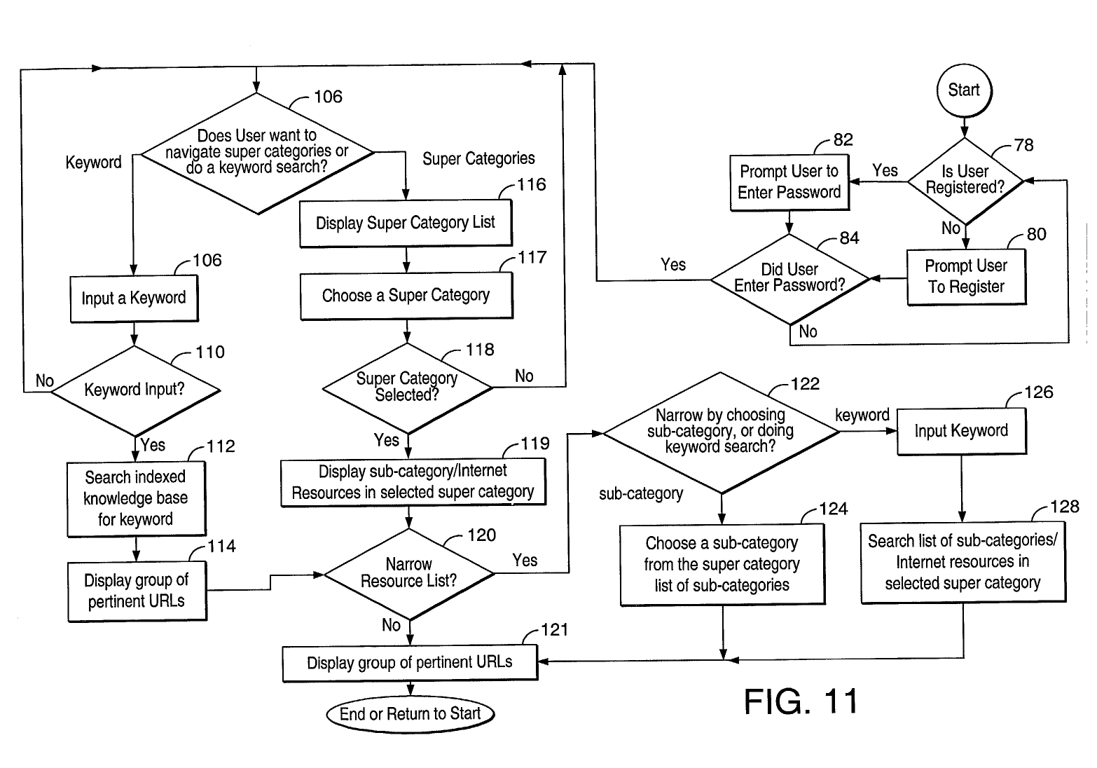

FIG. 11 is a flow diagram illustrating an additional embodiment of the invention. In this embodiment, the initial processing of steps 78 through 84 are the same as described above in FIG. 10. After verifying that the customer/user input the password, he or she may choose whether to perform a navigated search of the super categories, or a free form keyword search of the indexed knowledge base 106.

If the customer/user chooses to perform a keyword search 106, he or she is prompted to input a keyword 108. Verification step 110 checks to see whether a keyword was input. At step 110, if no keyword was input, the customer/user is returned to step 106 and again asked whether to perform a navigated search of the super categories or a keyword search. If a keyword was input at step 110, the indexed knowledge base is searched for the keyword 112, and the customer/user's Internet appliance 16A-n displays a group of pertinent URLs 114. Following step 114, the customer/user is asked whether he or she would like to narrow the search 120. If no narrowing is required, the step 114 group of pertinent URLs is again displayed 121 and the process is ended. If additional narrowing is desired, the customer/user is asked whether he or she would like to narrow by choosing a sub-category, or by doing a keyword search 122. If a keyword search is selected, the customer/user is prompted to input a keyword 126, and the list of sub-categories and Internet resources in the selected super category is searched for any incident of the keyword 128. Likewise, if narrowing by sub-category is chosen, the customer/user selects a sub-category from the selected super category's list of sub-categories 124. Whether narrowing by sub-category or keyword is chosen, once the narrowing search is complete, the Internet appliance 16A-n displays a group of pertinent URLs 121, and the process is ended, or the customer/user may choose to begin the process again by returning to “start.”

Referring back to step 106, if the customer/user chooses to navigate the super categories, the Internet appliance displays a list of the super categories 116 and the customer/user is prompted to choose a super category 117. Verification step 118 checks to see whether a super category was selected. If no super category was selected, the customer/user is returned to step 106, where the process begins anew. If a super category was selected, the Internet appliance displays a list of sub-categories and Internet resources available in the selected super category 119. The customer/user may then decide whether to further narrow the search 120. If no further narrowing is required, the Internet appliance displays a group of pertinent URLs 121. If further narrowing is desired, the customer/user follows the process beginning with step 120 as described above.

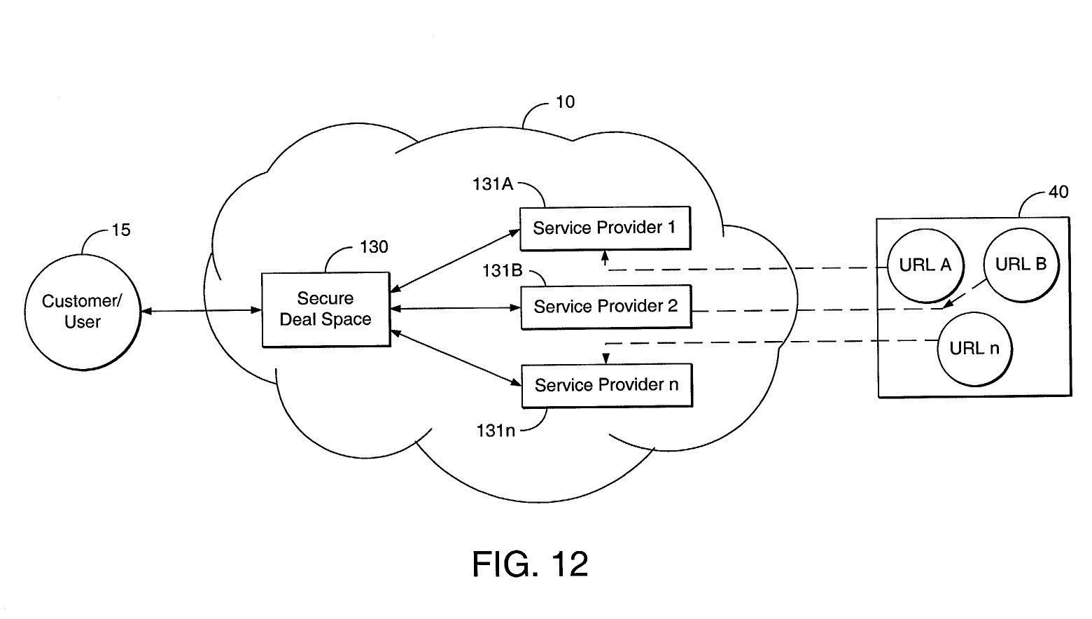

FIG. 12 shows an optional deal space feature that may be implemented in an embodiment of the invention. In FIG. 12, the customer/user 15 locates a group of pertinent URLs 40 that lead to multiple resources, or service providers 131A-n, each suited to participate in his or her project. The customer/user may then access a secured deal space 130 where he or she can ask these service providers to bid for participation in the project. One skilled in the art would be familiar with secure deal spaces, examples of such a deal space include, but are not limited to, the services on Internet Websites such as www.masterdealmaker.com, www.newchanges.com, or the like.

In one such embodiment, after identifying potential service providers 131A-n, the customer/user may fill out a pre-processed form and submit it to the secured deal space 130. The form is preferably an electronic form and may be a template, a Word™ document, a WordPerfect™ document, an e-mail, or the like. This form may, for example, identify the project's nature, schedule, and budget, as well as the target service providers. Once submitted to the secure deal space 130, these forms may be submitted for bidding to the target service providers, without divulging the customer/user's identity and/or competing service providers. The customer/user may periodically check in, may be notified each time the secure deal space receives a bid, or may receive all bids on a date certain as defined by the customer/user. After all of the bids are in, the customer/user may review the bids, selecting the best service provider to assist with his or her project.

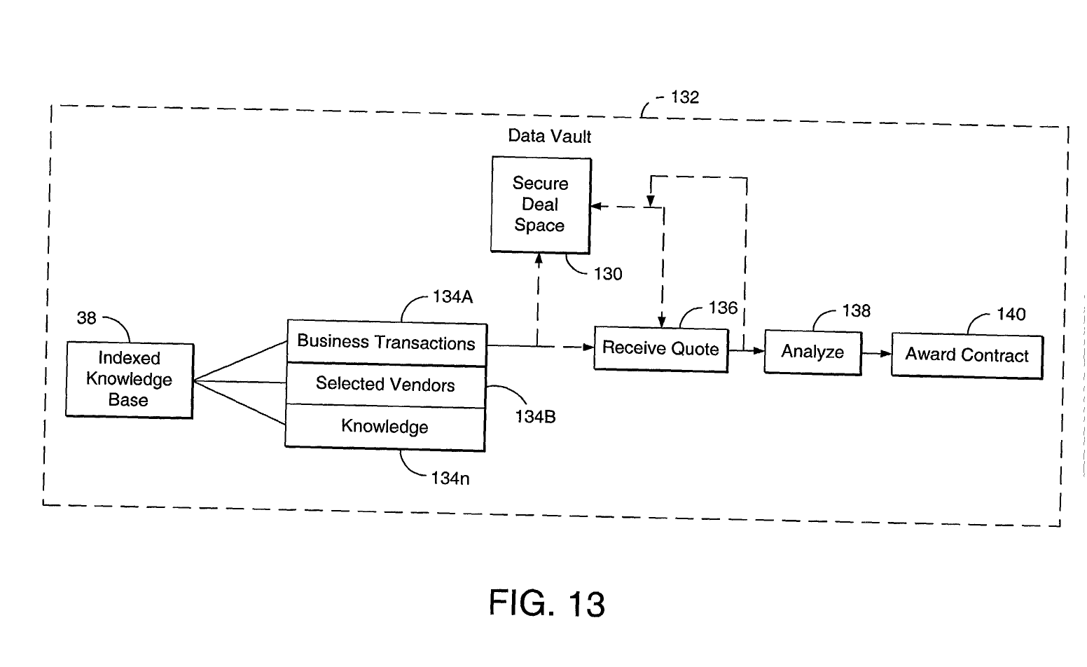

FIG. 13 is an example of an optional data vault 132 that may be used as an archival location for storing information associated with Website 8. The data vault's archival location may be in memory 6 in server 2, which hosts Website 8, in memory 20A-n corresponding to the customer/user's internet appliance 16A-n, on a client server associated with an Internet web browser, or the like. In one embodiment, data vault 132 stores indexed knowledge base 38 transactions, wherein a search of the indexed knowledge base produces a selection of information including, for example, information about potential business transactions 134A, selected vendors 134B, and project knowledge 134n. Using this information, a user may conduct a business-to-business transaction in secure deal space 130 by sending a request for quotes, to desired vendors and receiving a response to the same 136. A customer/user may choose to maintain these quotes 136 in the secure deal space 130 for later action, or may choose to make a decision by analyzing the quotes 138 and awarding a contract 140. The entire transaction may be made in the secure deal space, and the results of each step maintained as a record in data vault 132. Other similar business-to-business transactions include, but are not limited to selecting and purchasing an Internet catalog item, attending an Internet auction, or entering a services exchange.

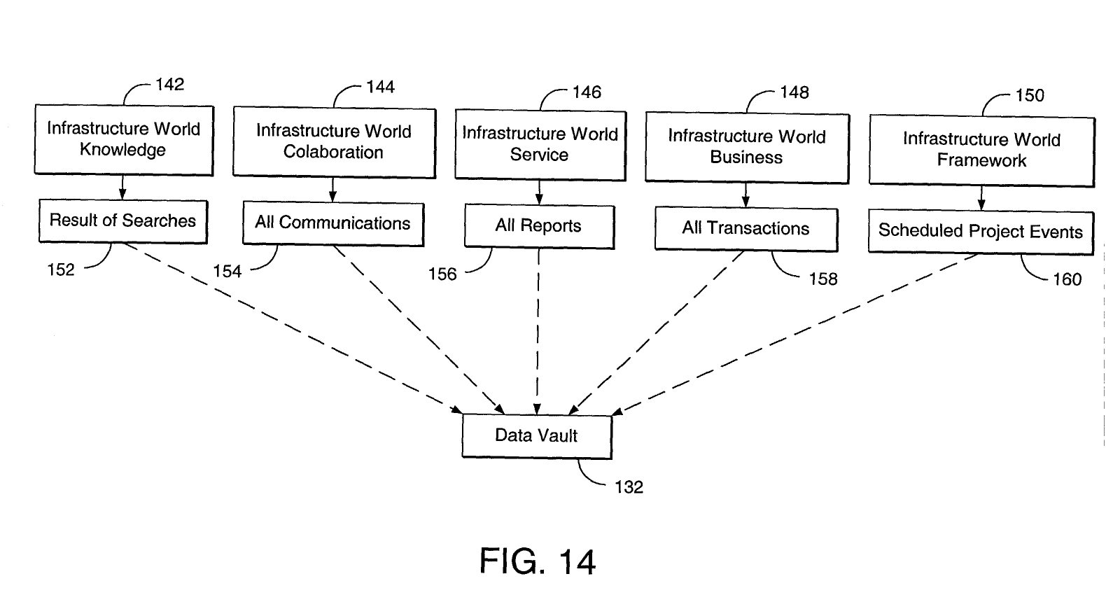

FIG. 14 is a further example of a data vault 132 as used in an embodiment of the invention wherein the data vault is implemented to store information immediately associated with the project tools 142, 144, 146, 148, and 150 of the Website 8. The information stored in the data vault may be maintained for a project's life cycle, even if that life cycle extends for forty years or more. Also, the data stored in a data vault may be maintained at different levels of security depending on the customer/users instructions. And, data vaults may be searchable.

The information stored in data vault 132 is not limited to conducting electronic transactions in the secure deal space. Instead, this information is versatile and may be retrieved for uses such as online Internet based conferencing, or other communications. The data vault may be used for storing any type of data. Among others, these data types include document data, programming data, algorithmic data, Website data, online conferencing data, video data, audio data, and the like.

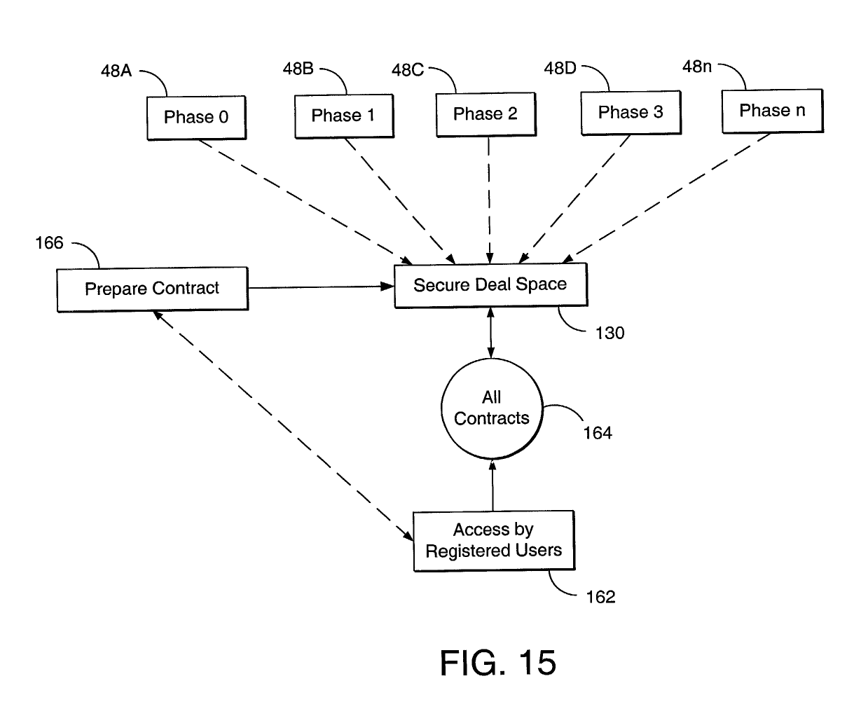

FIG. 15 is an example of a business-to-business transaction in a secure deal space where the transactions are performed according to a project's Life Cycle phase 48A-n.

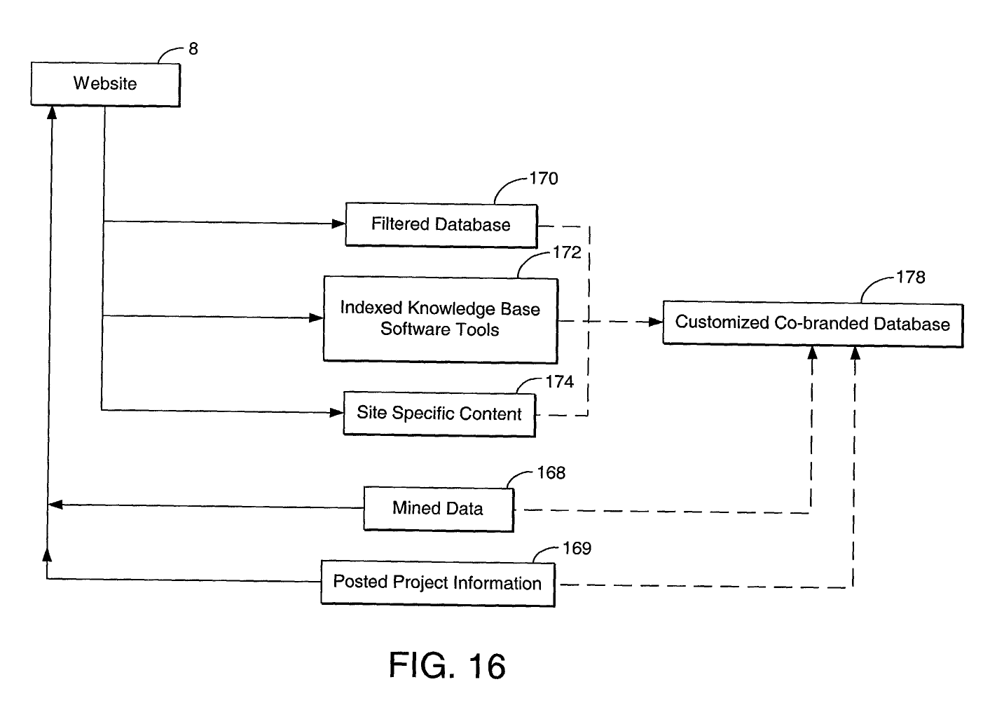

FIG. 16 is an example of Website co-branding. Website co-branding creates a secondary knowledge base from information on Website 8, and in indexed knowledge base 38. Co-branded Websites have a searchable database 176 containing less than all of the nodes in the indexed knowledge base of Website 8.

Negotiating several steps may create a co-branded Website, including a customized co-branded database 176. One step may be filtering the indexed knowledge base 38 for URLs satisfying certain criteria, and combining the results of that filtering to create a filtered database 170. Depending on the purpose of the co-branded Website, the criteria may include such things as, for example, all URLs related to a specific Country, Region, Industry, or market sector. A second step may be implementing software tools 172 for use with the indexed knowledge base 38. These software tools may be used in conjunction with an Internet web browser for identifying URLs not otherwise included in indexed knowledge base 38, but that satisfy the customer/user defined criteria for URLs and Websites to be included in the co-branded knowledge base. A third step may be defining Website specific content 174, that should be included in the co-branded Website even if it is information not otherwise defined by the filtering criteria of step 170. This content may include, but is not limited to, such things as specific Websites, business-to-business access, search methods, a certain look and feel, or the like.

In addition to steps 170, 172, and 174, using Website mining technologies 168, which include technologies for appropriate Website identification, Website extraction, and Website importation, among others, may refine the content in a co-branded Website, as well as add pertinent URLs to the Website 8 indexed knowledge base 38. These technologies may include, among others, the technologies described in the search techniques accompanying FIG. 2. In particular, applicable features may include those associated with meta browsers such as Surfwax™. Also, these methods may include using software agents such as those discussed in connection with FIG. 5, for organizing a database directory by performing such tasks as removing dead and duplicate URL links. Further, Internet based editing tools may be used for mining data 168. An Internet editing tool may allow an editor to classify a Website, maintaining the classification and adding searchable descriptors from snapshot summaries.

The information included in a customized co-branded database 176 may include information associated with a project posted on Website 8. The nature of a posted project may or may not make the information associated therewith appropriate for inclusion in customized co-branded database 176.

A co-branded Website could be a Website focused on a region, city, or location, as well as a Website focused on a technology, business, market, industry, or project, for example.

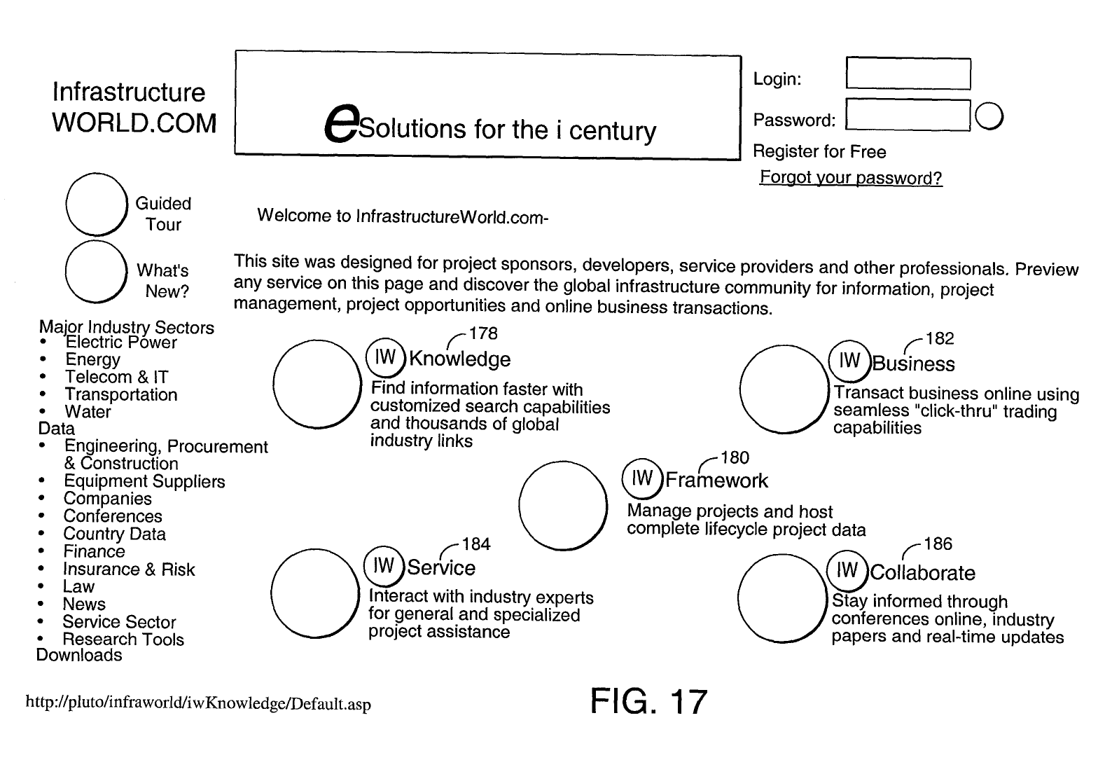

FIG. 17 illustrates an example of an initial screen that may appear upon access to the Website 8. The initial screen provides an image of a searchable data designed for project development, and including at least five distinct services: iwKnowledge 178, iwFramework 180, iwBusiness 182, iwService 184, and iwCollaborate 186. The service iwKnowledge 178 allows customers/users 15A-n to quickly find information using customized search capability with thousands of global industry links. The service iwFramework provides a full life cycle project management tool for managing every lifecycle phase of a project. The service iwBusiness 182 is a service for transacting online business by implementing such tools as secure deal space 132. The service iwService allows users to interact with industry experts for general and specialized project assistance. The service iwCollaborate allows customers/users to stay informed by using online conferencing, accessing industry specific papers and journals, receiving real-time e-mail updates, receiving real-time news updates, and the like. The backbone of the Infrastructure World Website is a searchable indexed knowledge base 38.

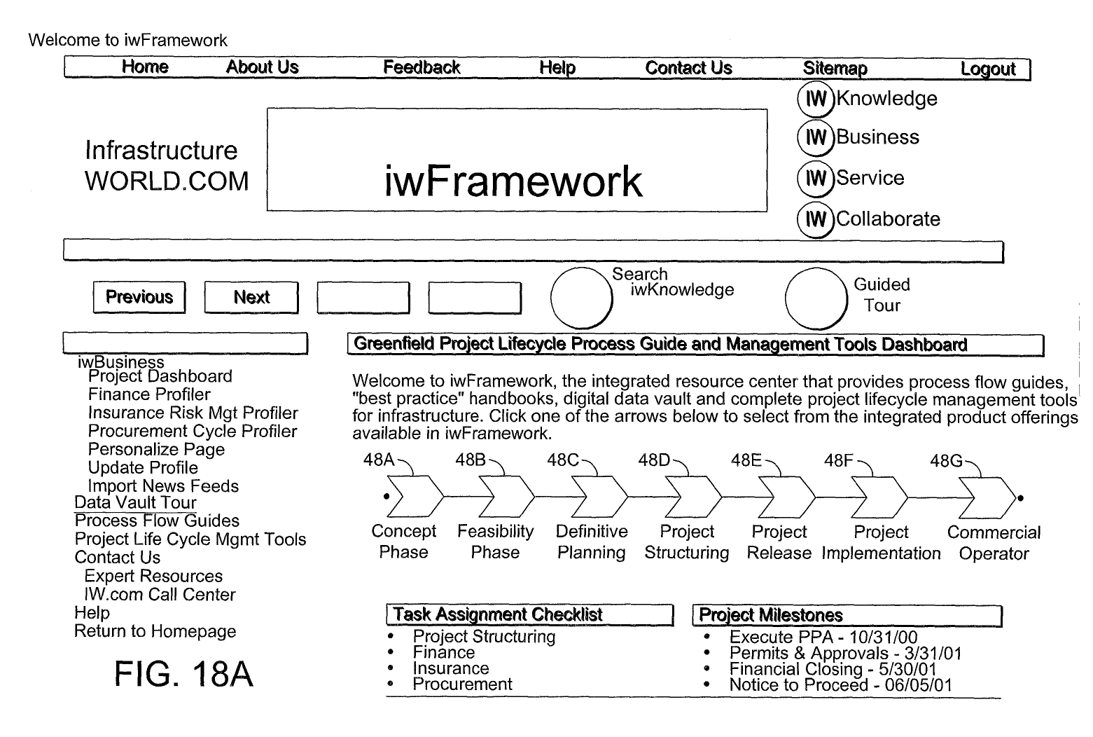

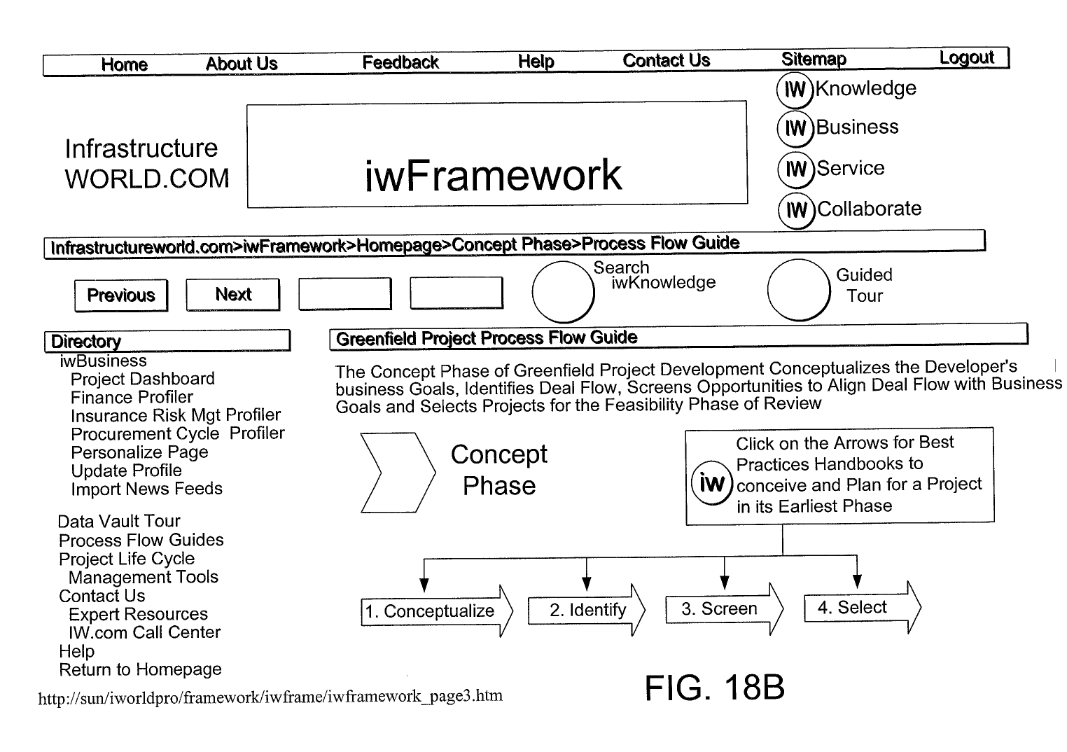

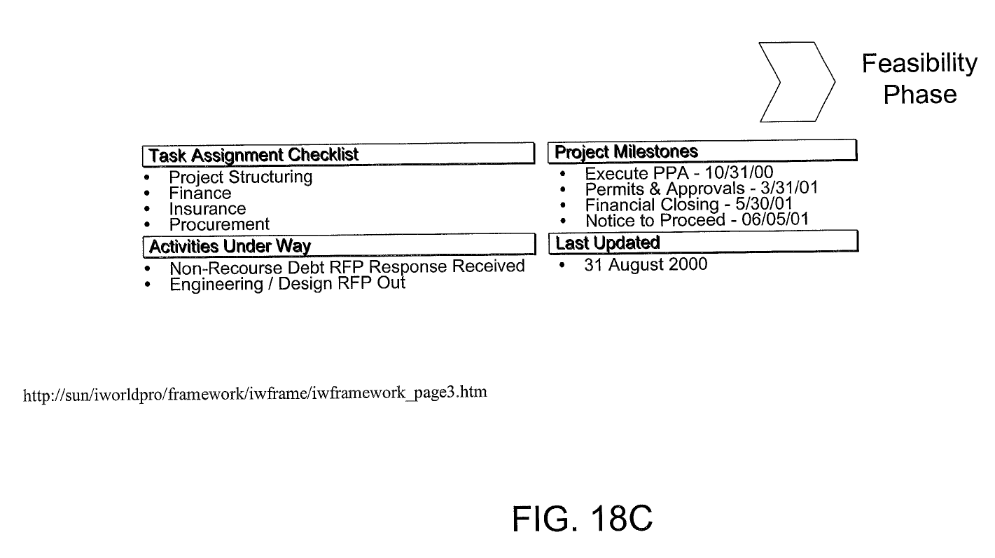

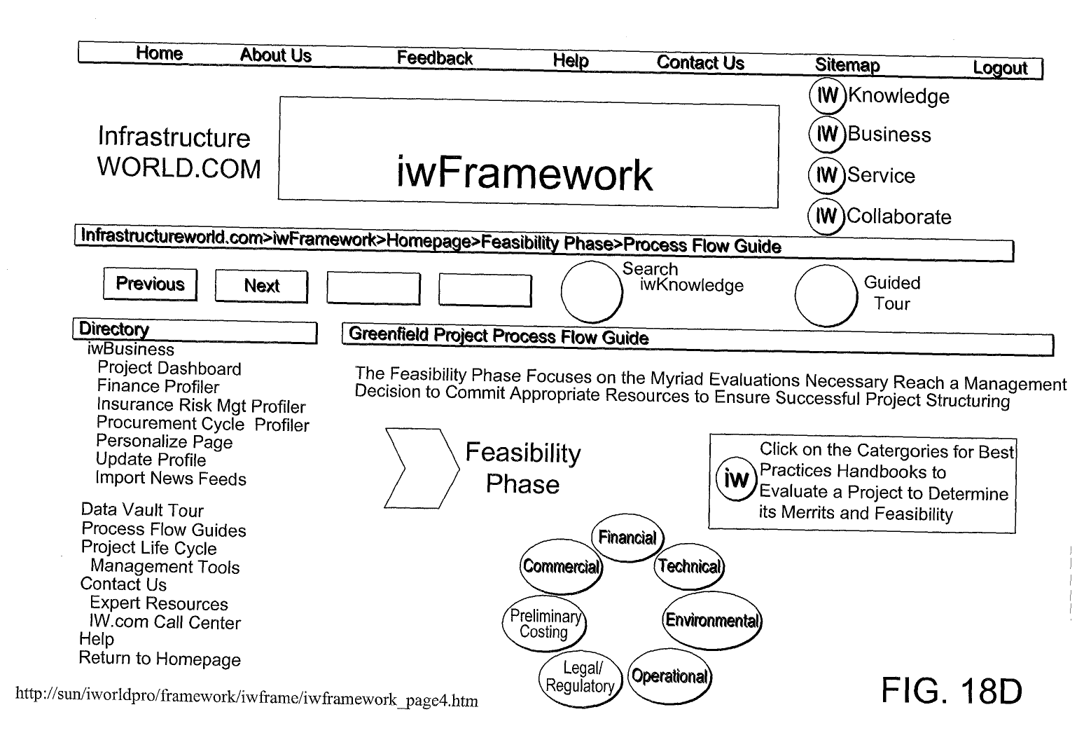

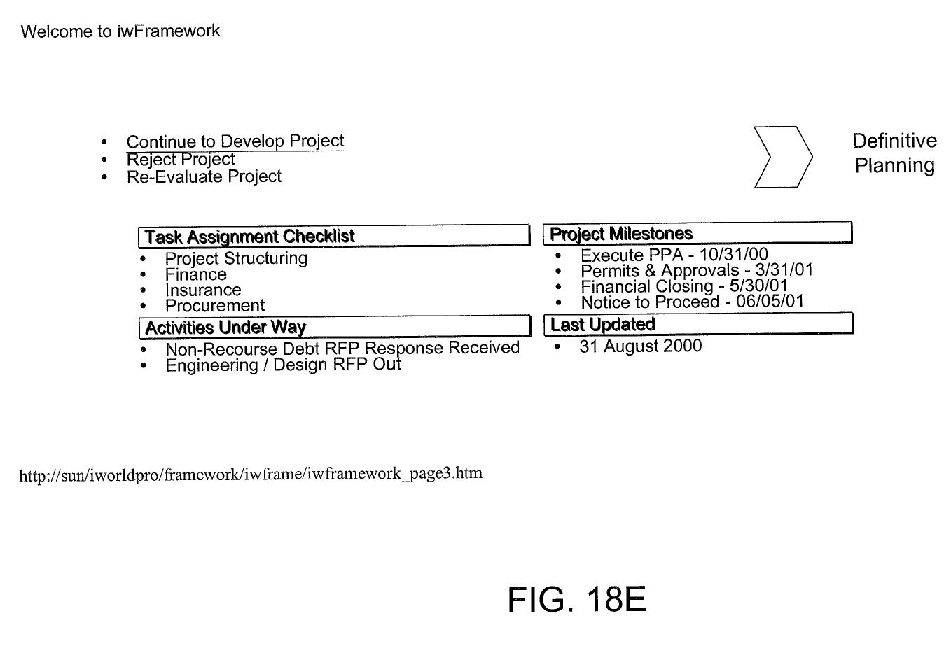

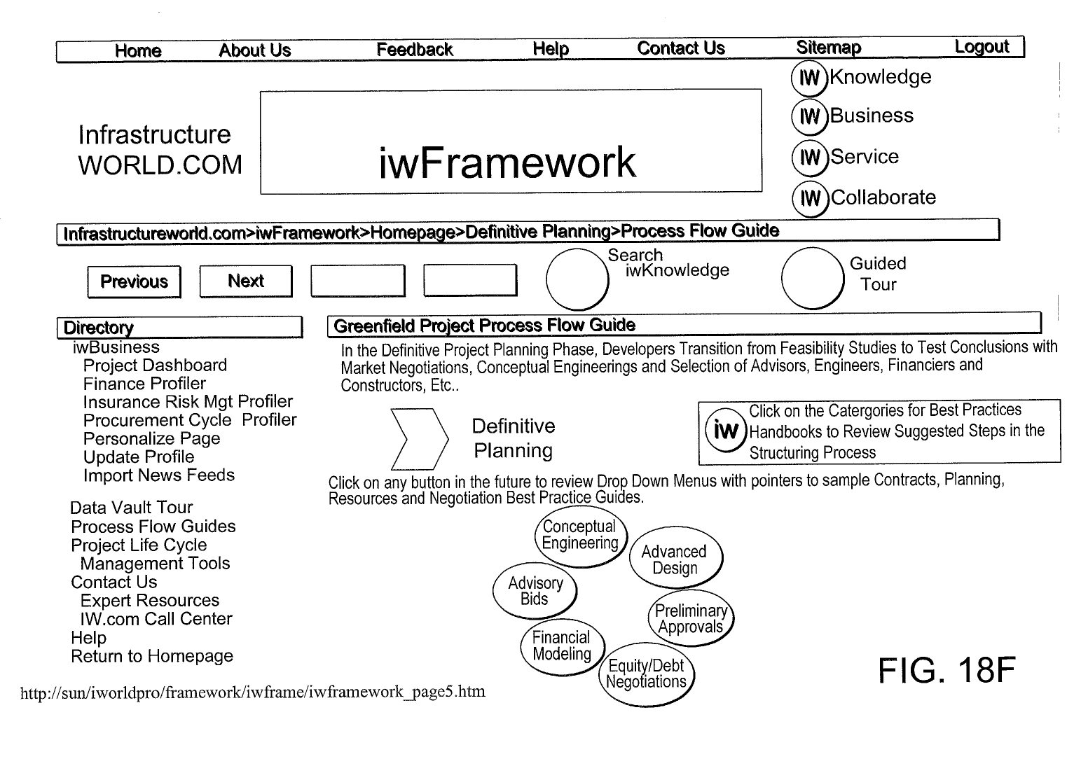

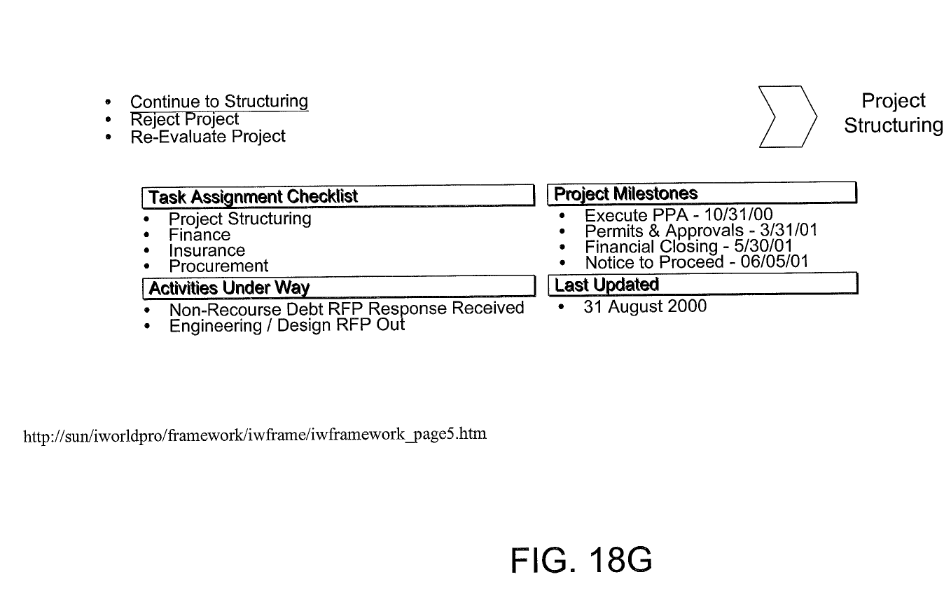

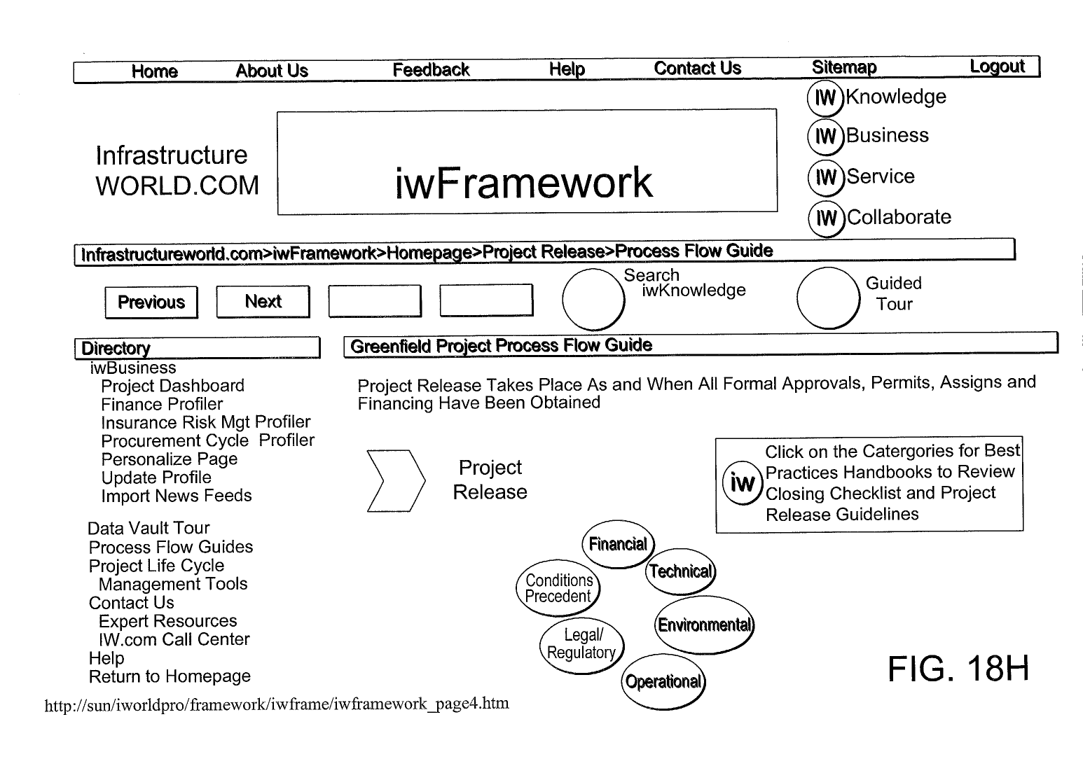

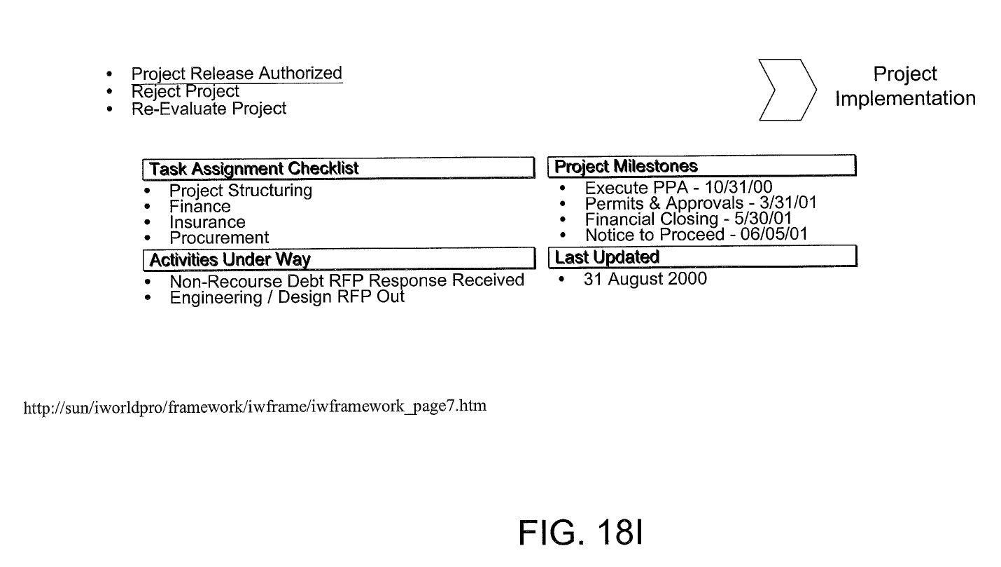

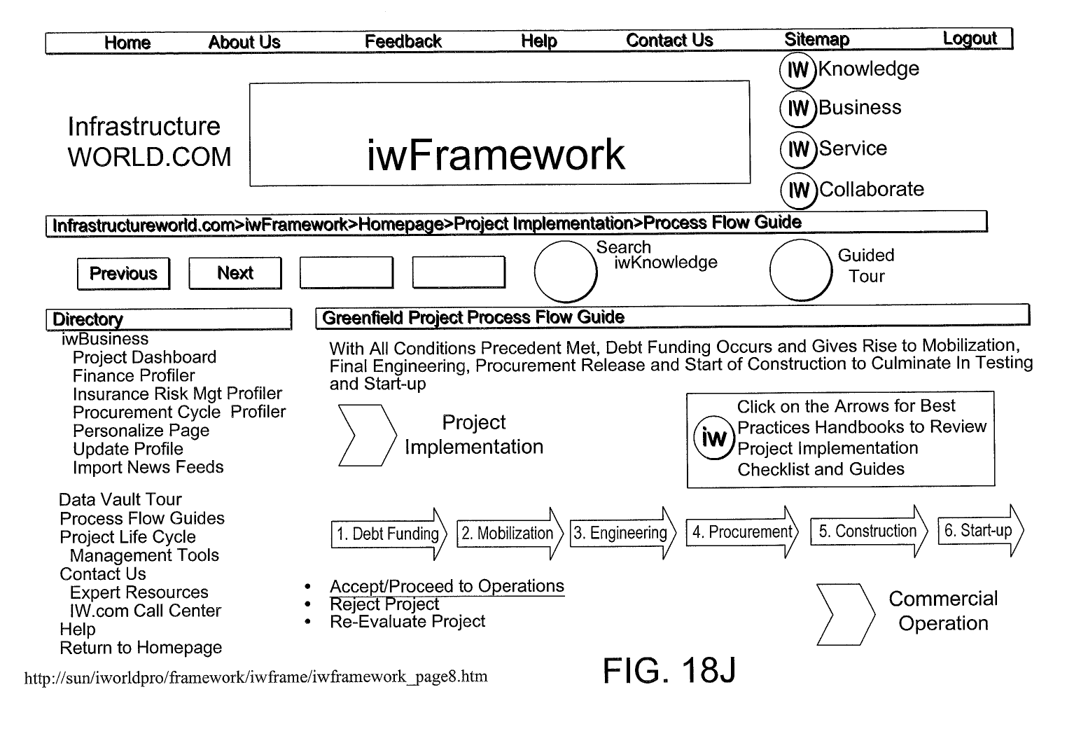

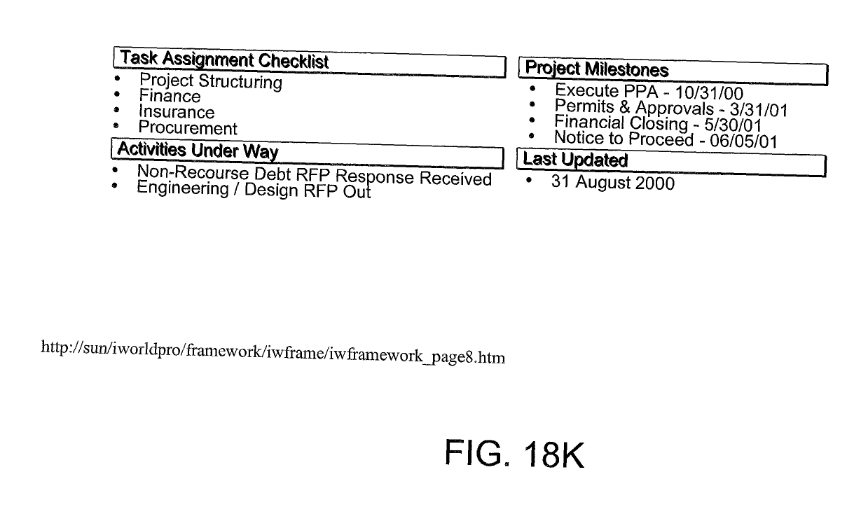

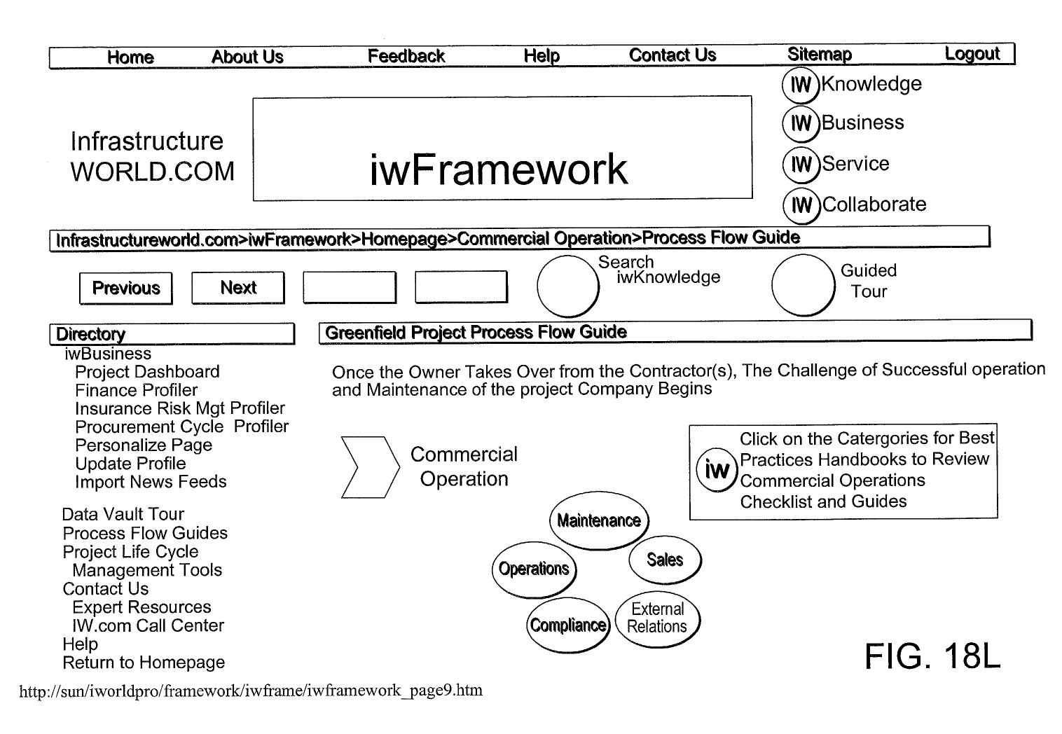

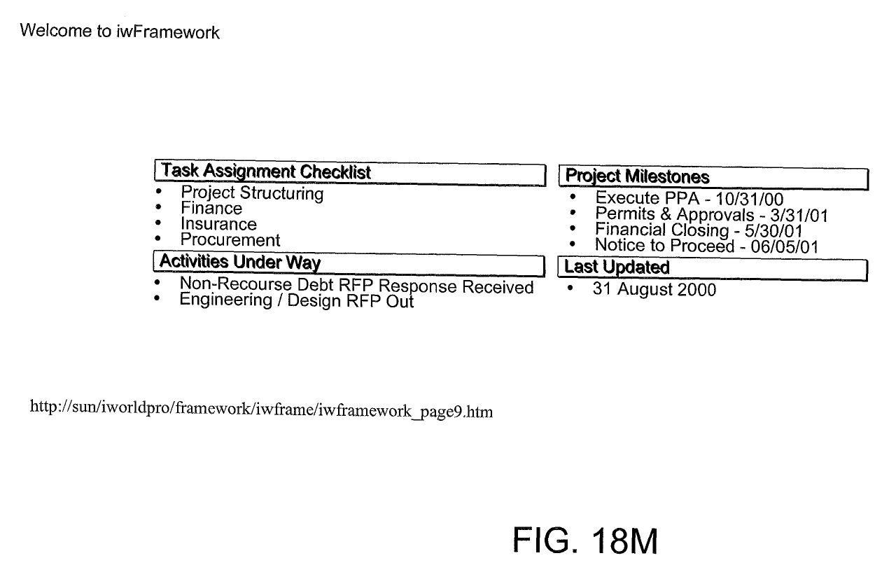

FIGS. 18A-M are screen shots highlighting the details of the service iwFramework, as included in an embodiment of the Website 8, where Website 8 is the Infrastructure World Website. Generally, iwFramework creates a comprehensive life cycle web based management system using distributed and/or central systems. This life cycle management allows business customers/users to manage each phase of a project from cradle to grave. The iwFramework tools include project transaction and budgeting tools. Other iwFramework tools provide for on line collaboration and communication for effectuating a project's phase goals

For example, at the Infrastructure World Website, iwframework is a tool that creates a comprehensive life cycle Internet based management system. This tool may use distributed and/or central systems. In use, iwFramework allows a client/user to engage in phase-by-phase project management, including every phase from cradle to grave. Also, iwFramework may provide project management tools for monitoring and controlling project transactions, budgets, and schedules. These tools may include, but are not limited to Internet tools for telephony, group conferencing, group collaborations, transacting deals in a secure deal space, global scheduling, shared scheduling, project management, procurement, access to industry papers, real time news updates, e-mail updates, and the like. IwFramework may provide access to Internet resources whether they have a URL or are identified by other means, such as a hard document link or an e-mail address. Also, iwFramework is a tool for integrating the iwKnowledge, iwCollaborate, iwService, and iwBusiness processes, also available on the Infrastructure World Website.

In one embodiment, iwFramework provides all or portions of the software for conducting each of the processes available in the iwFramework tool. In another embodiment, iwFramework provides all or a portion of the software for conducting each of the processes available on the Infrastructure World Website. These processes include, but are not limited to active server pages.

In one embodiment of the invention, iwframework cooperates with a secured deal space where business-to-business transactions may be made. The transactions conducted in the secure deal space may be stored in a data vault 132 for later processing, editing, or historical purposes. The iwFramework tool may provide a data vault for storing all or portions of communications in a long-term searchable archive. One skilled in the art would be familiar with appropriate storage medium for the long-term storage of data.

FIG. 18A shows typical project phases 48 A-F. These project phases are illustrative of the type of project phases that might be included in a project's life cycle. These phases include concept phase 48A, feasibility phase 48B, definitive planning phase 48C, project structuring phase 48D, project release 48E, project implementation 48F, and commercial operation 48G.

FIGS. 18B-M are illustrative of the type of resource that may be available for different phases of a project

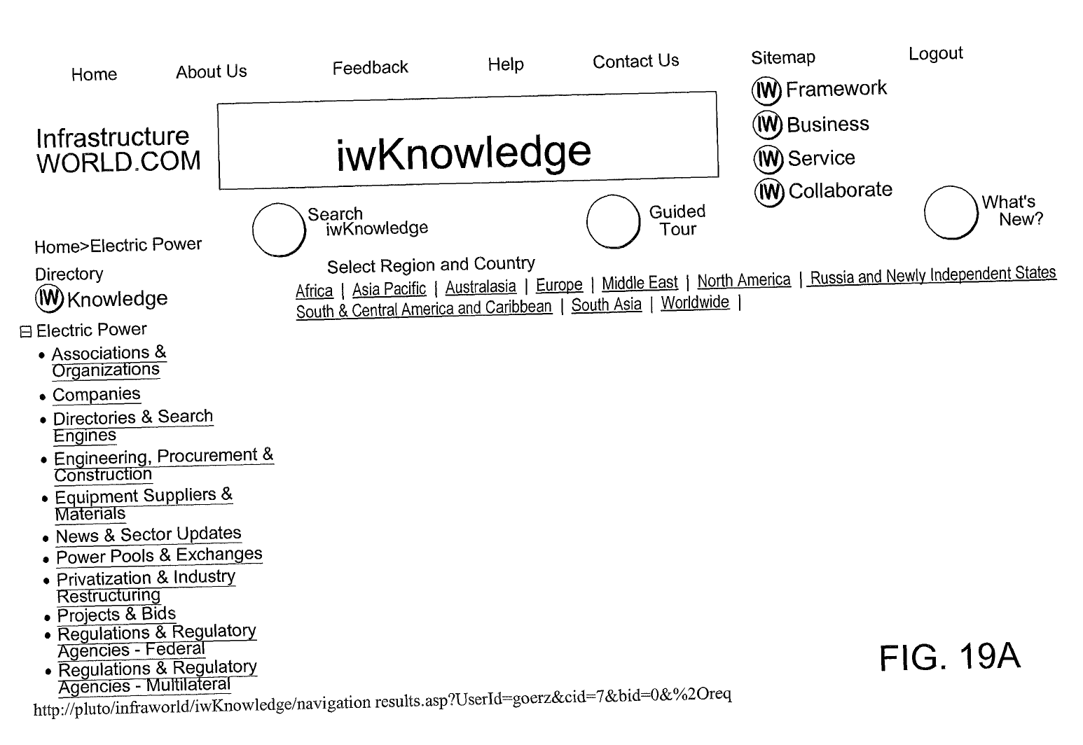

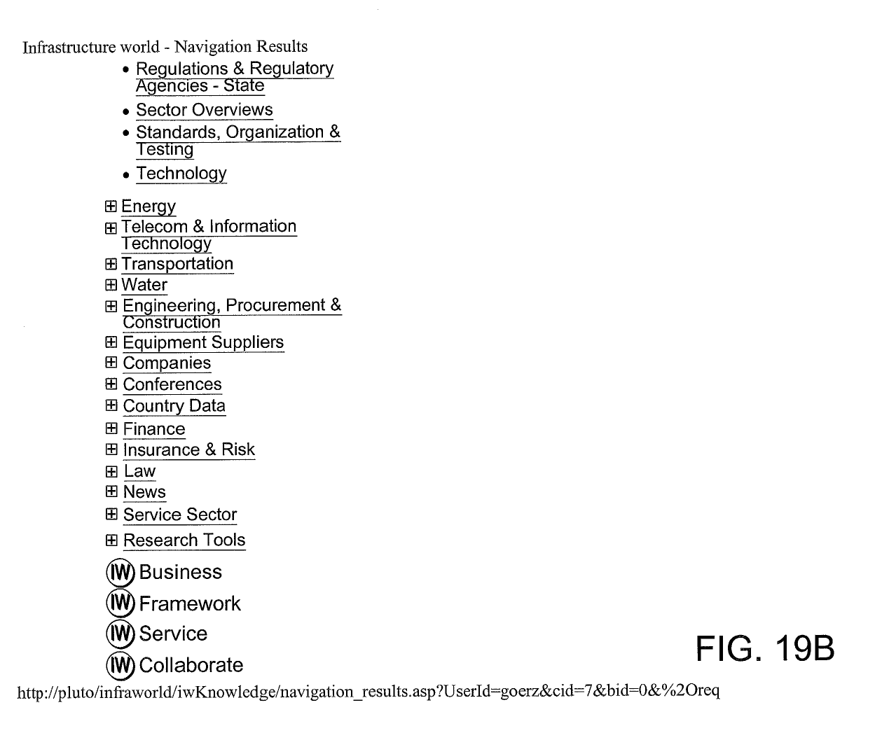

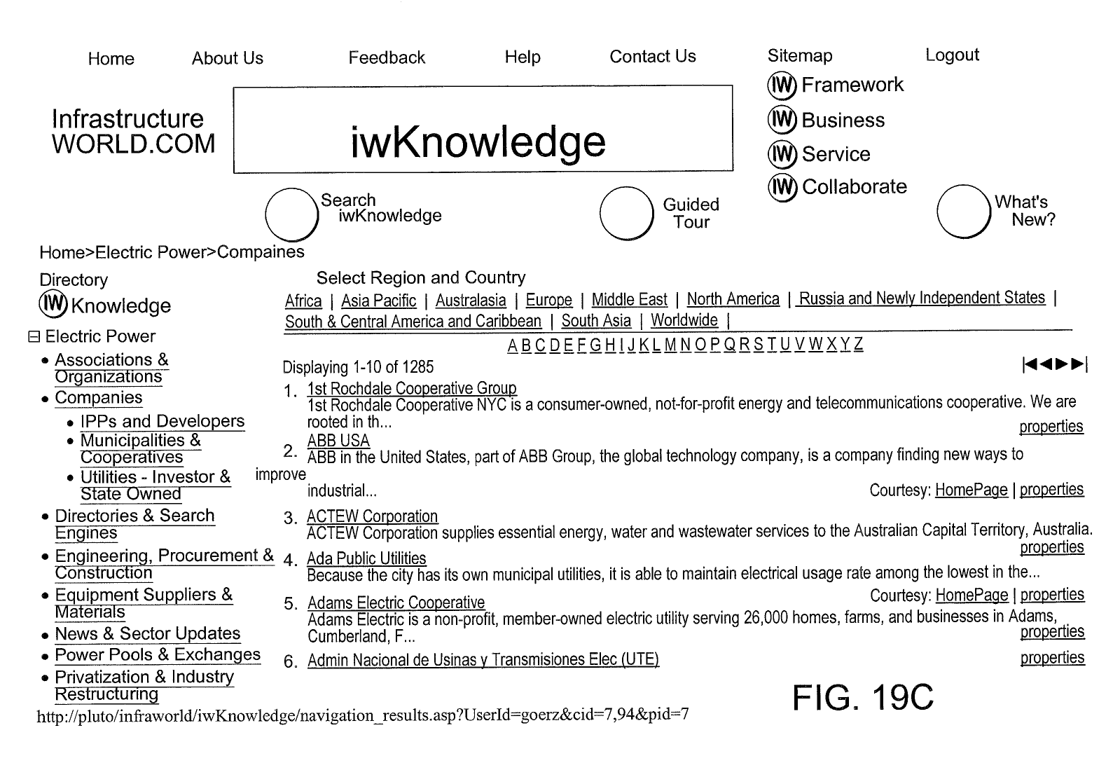

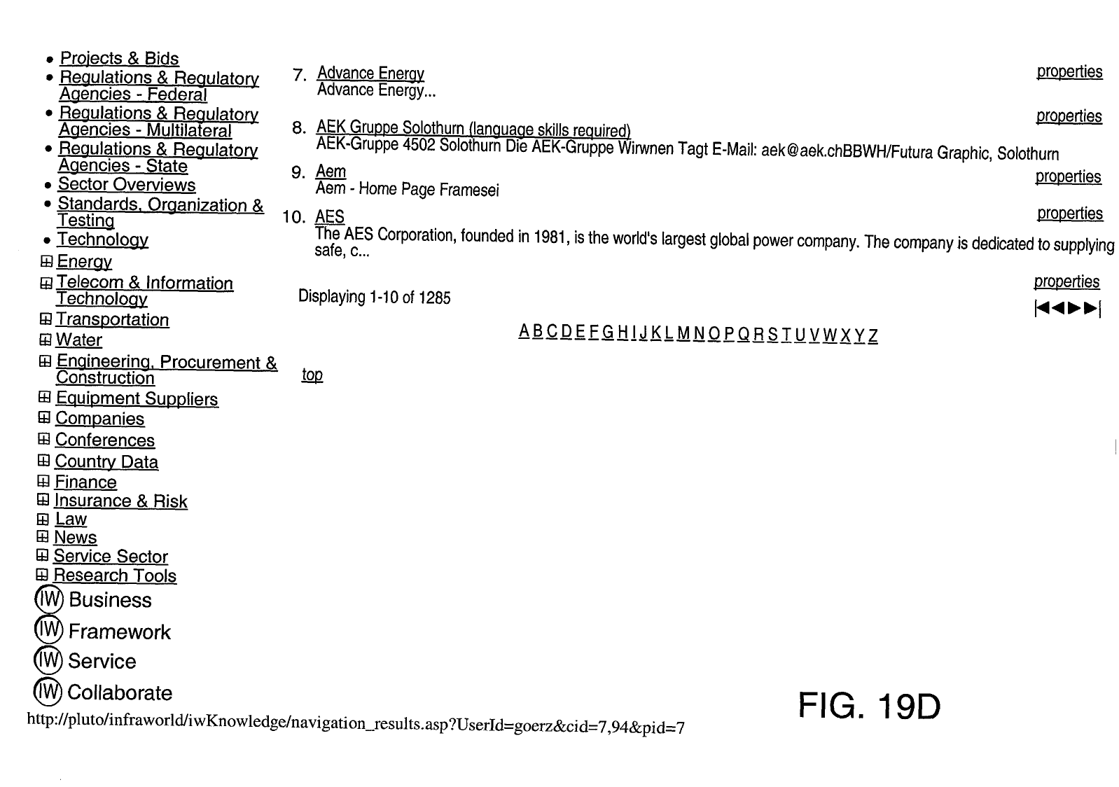

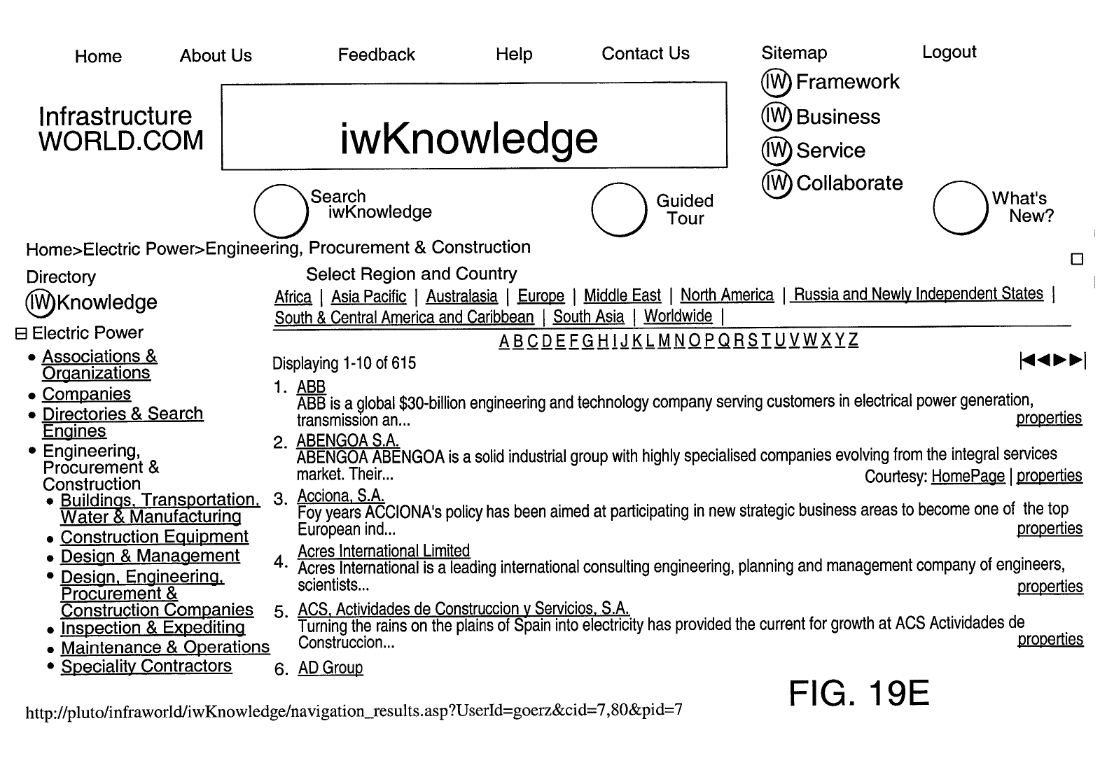

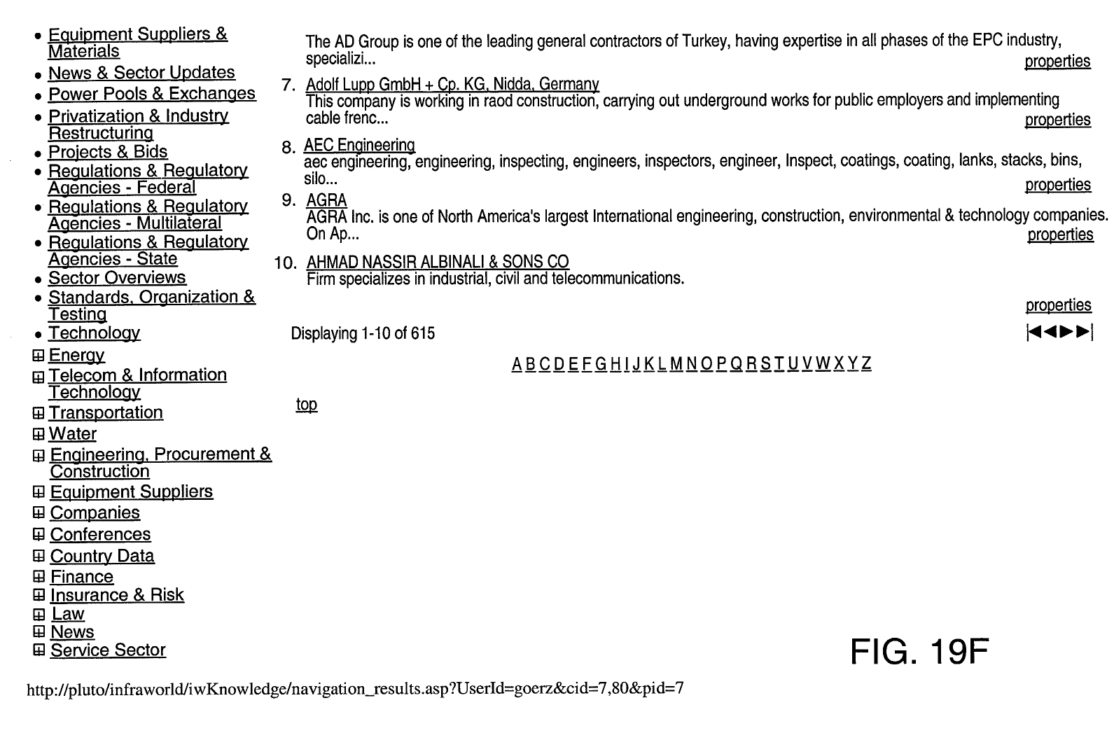

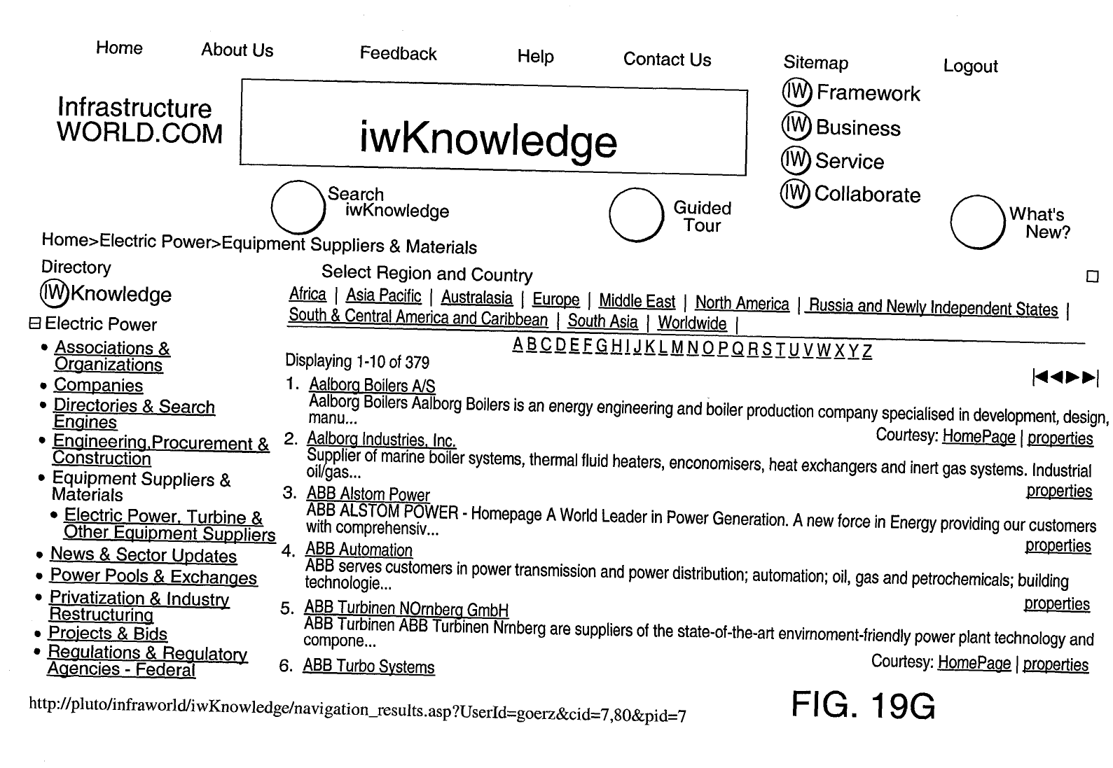

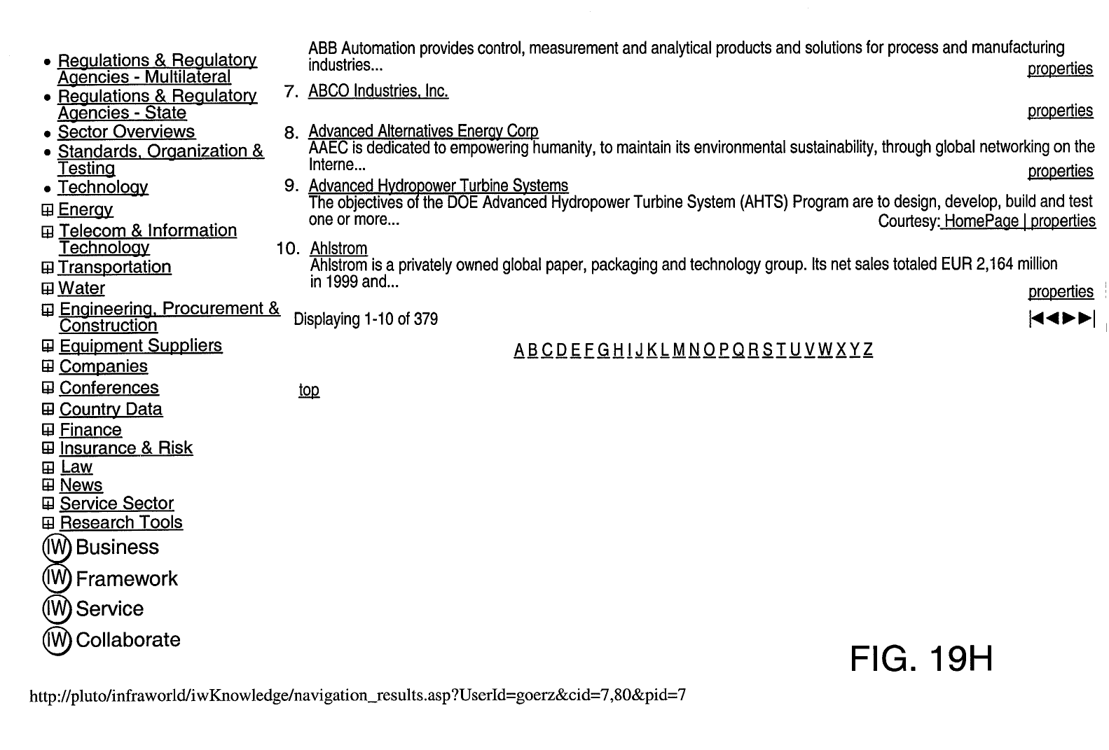

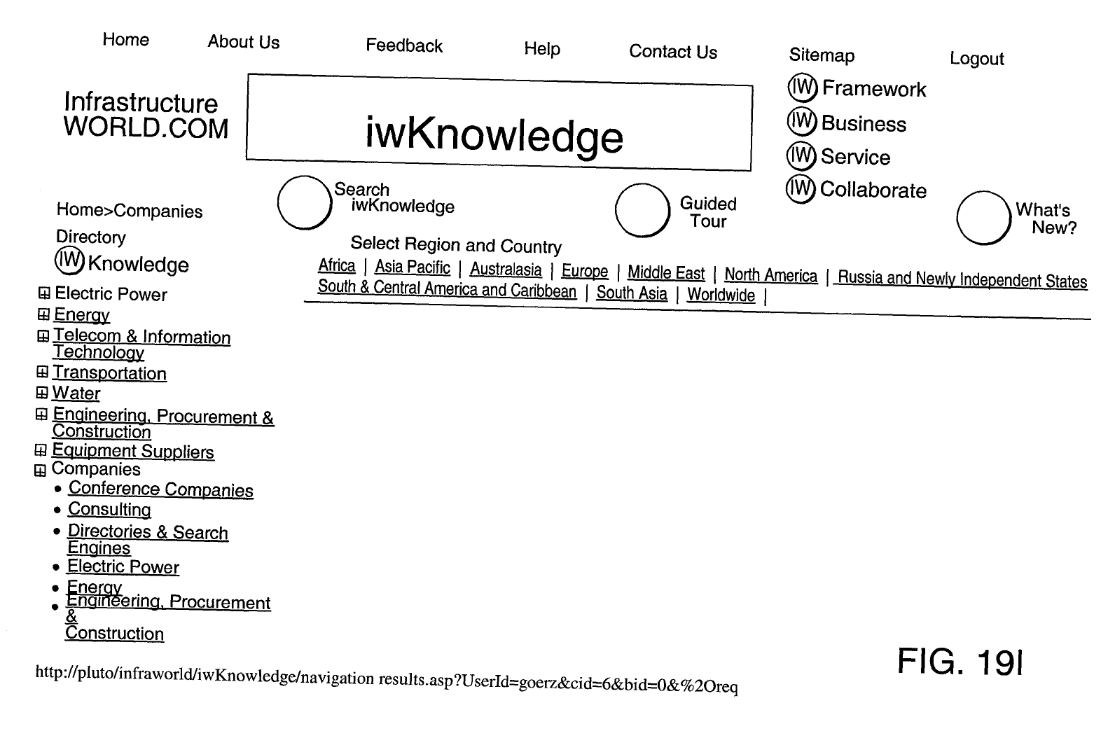

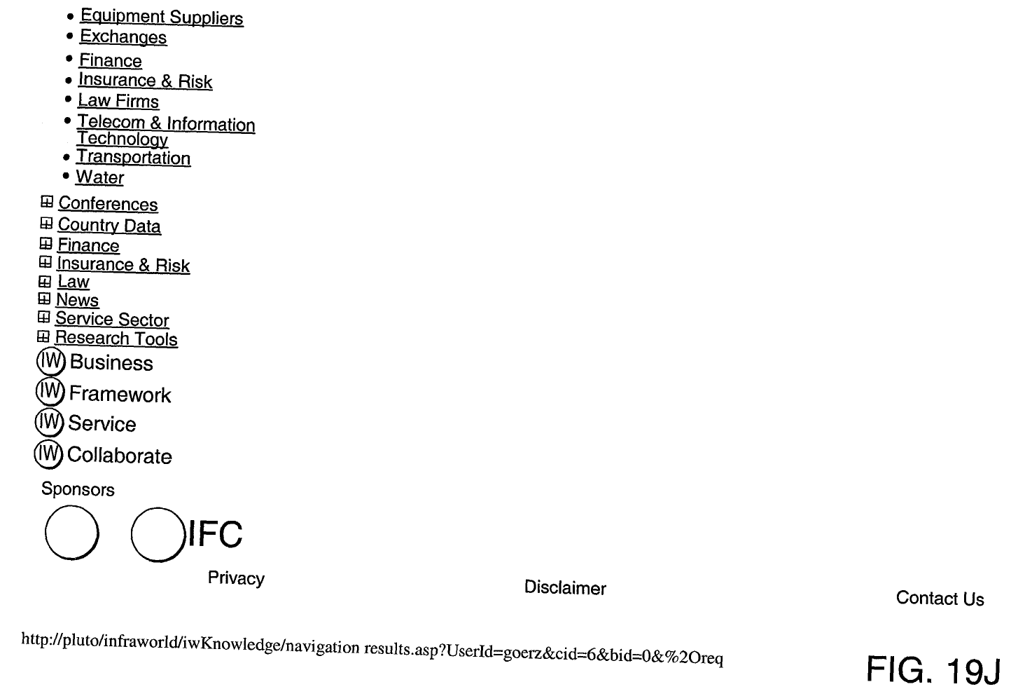

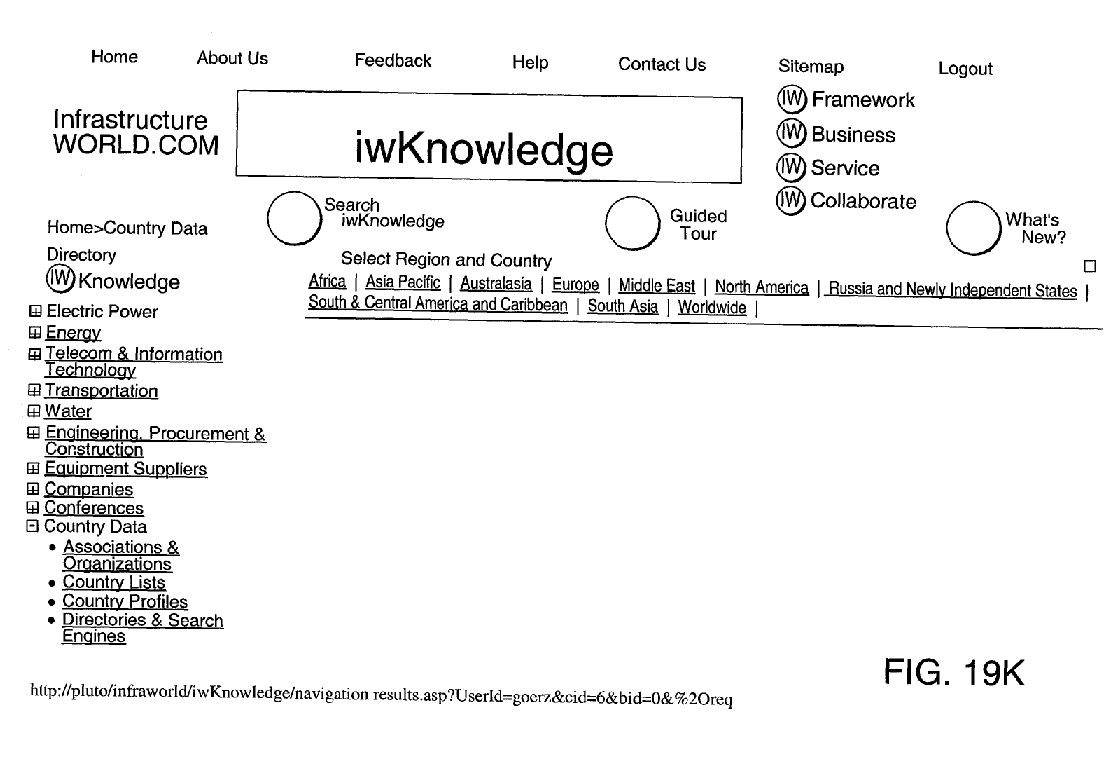

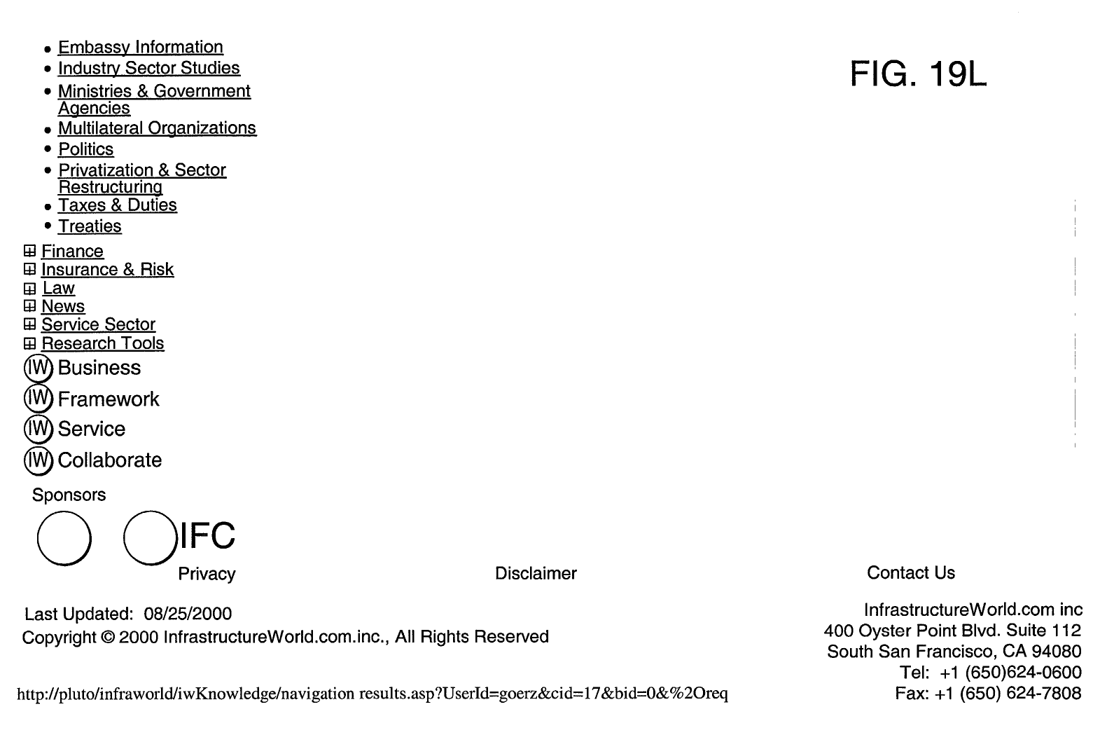

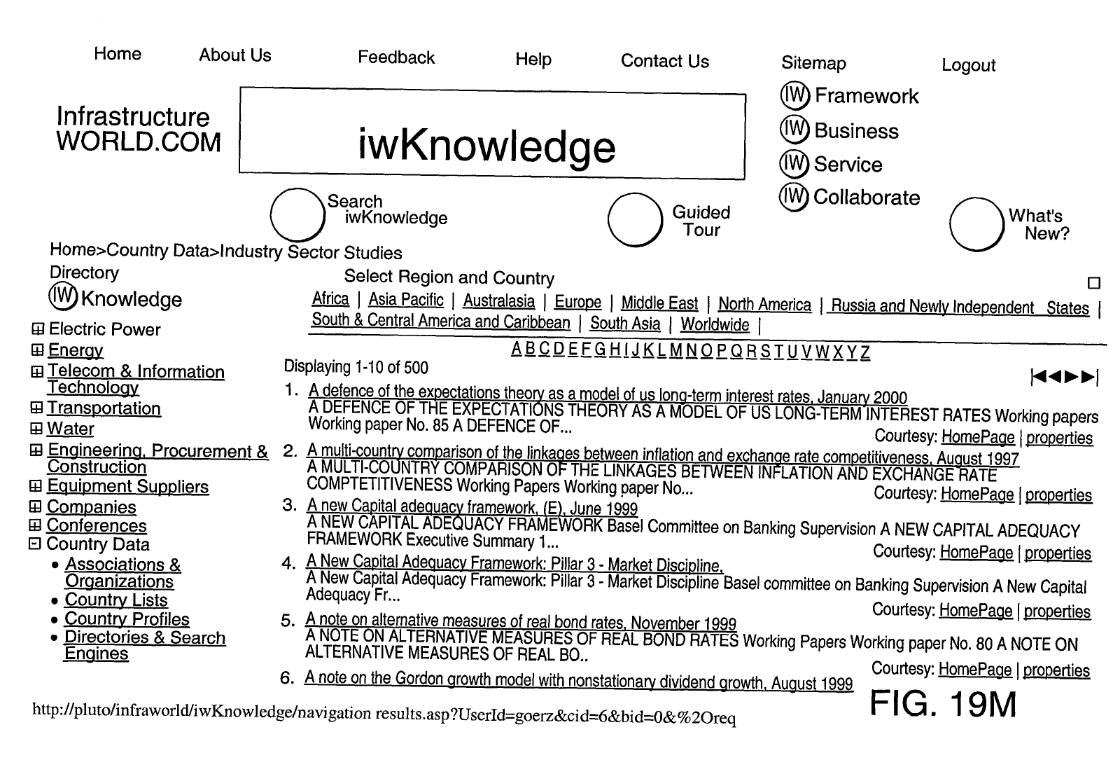

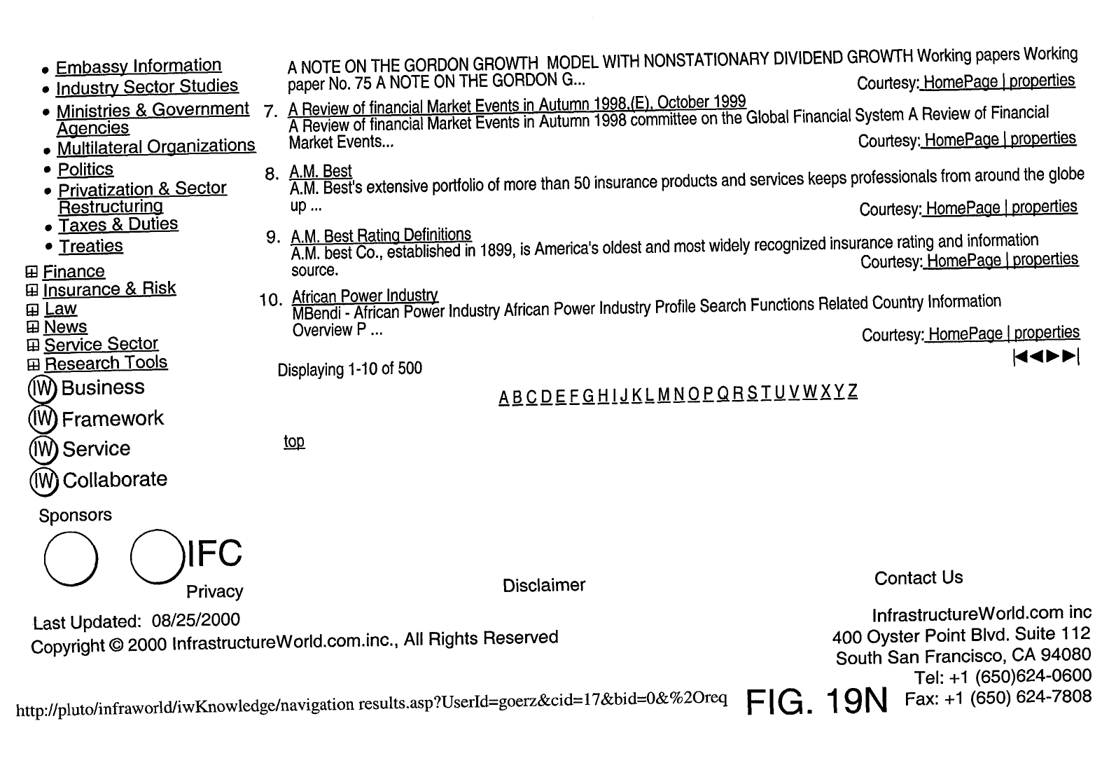

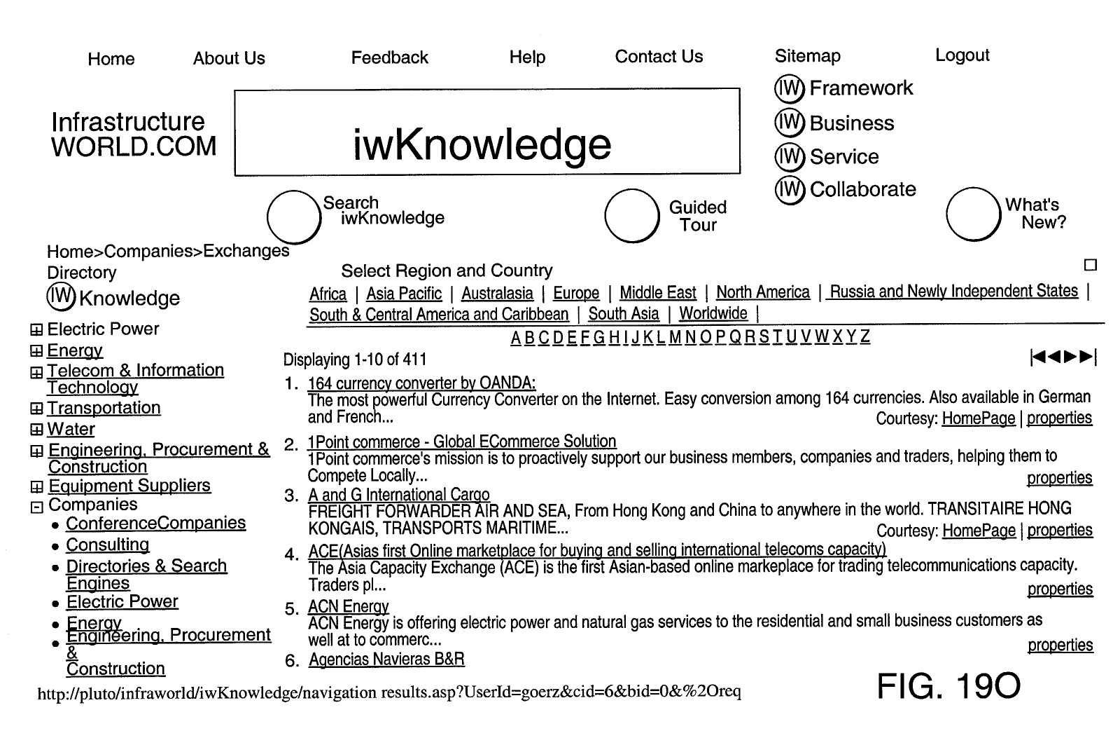

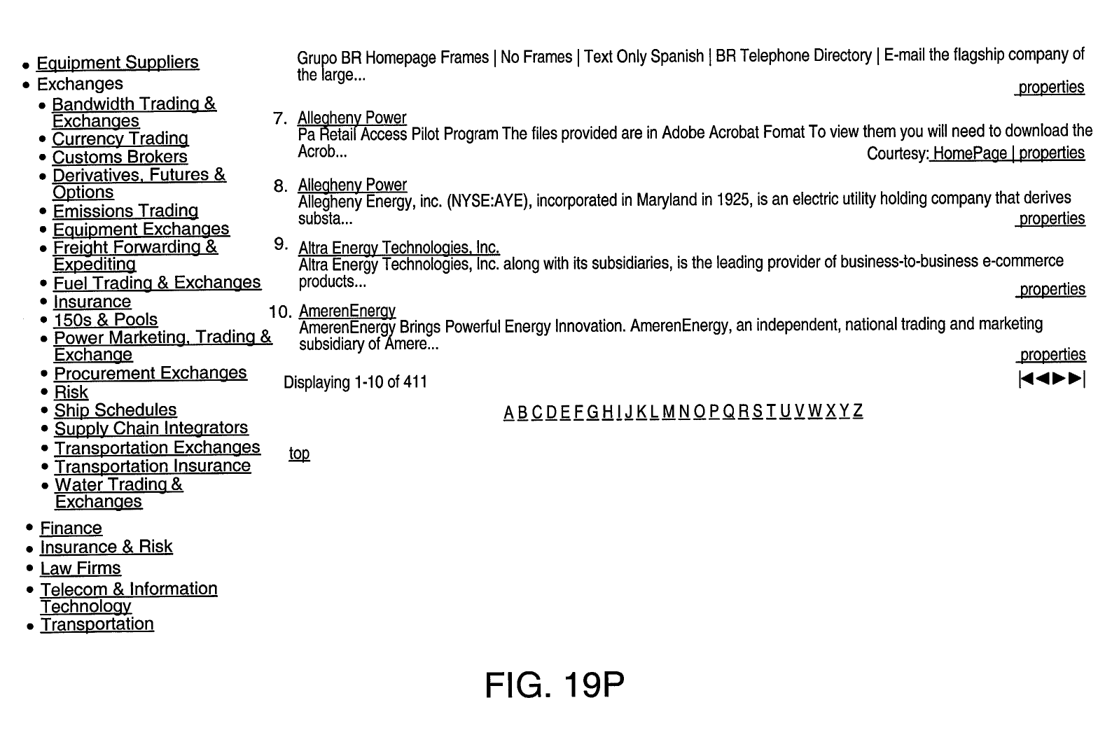

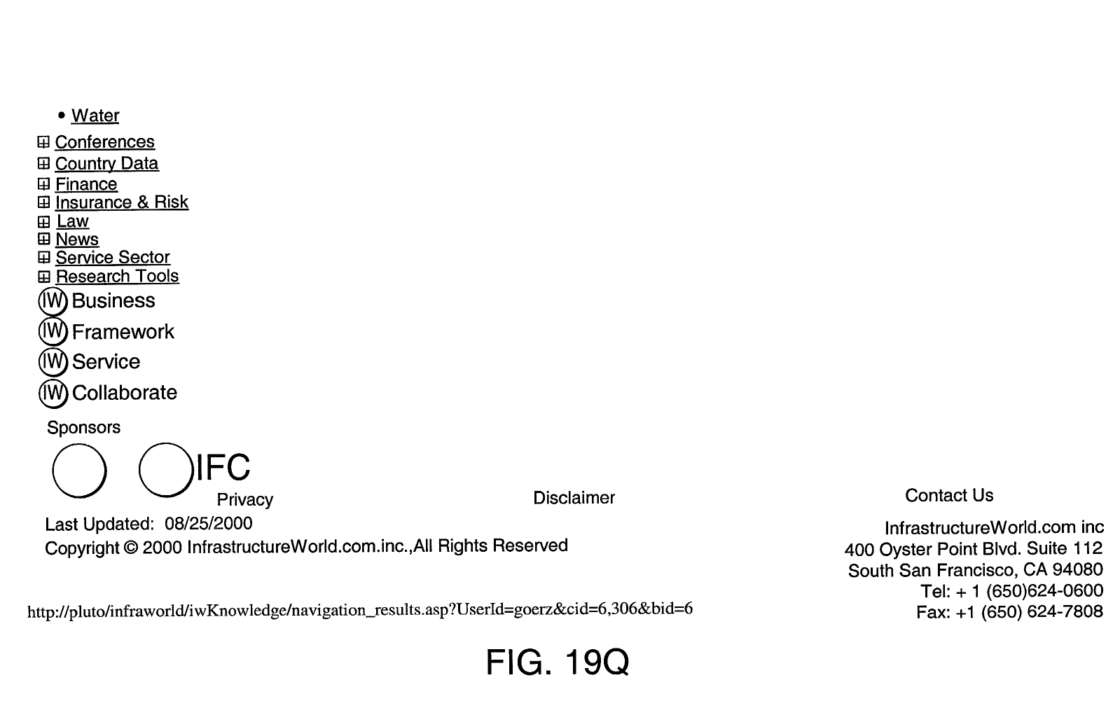

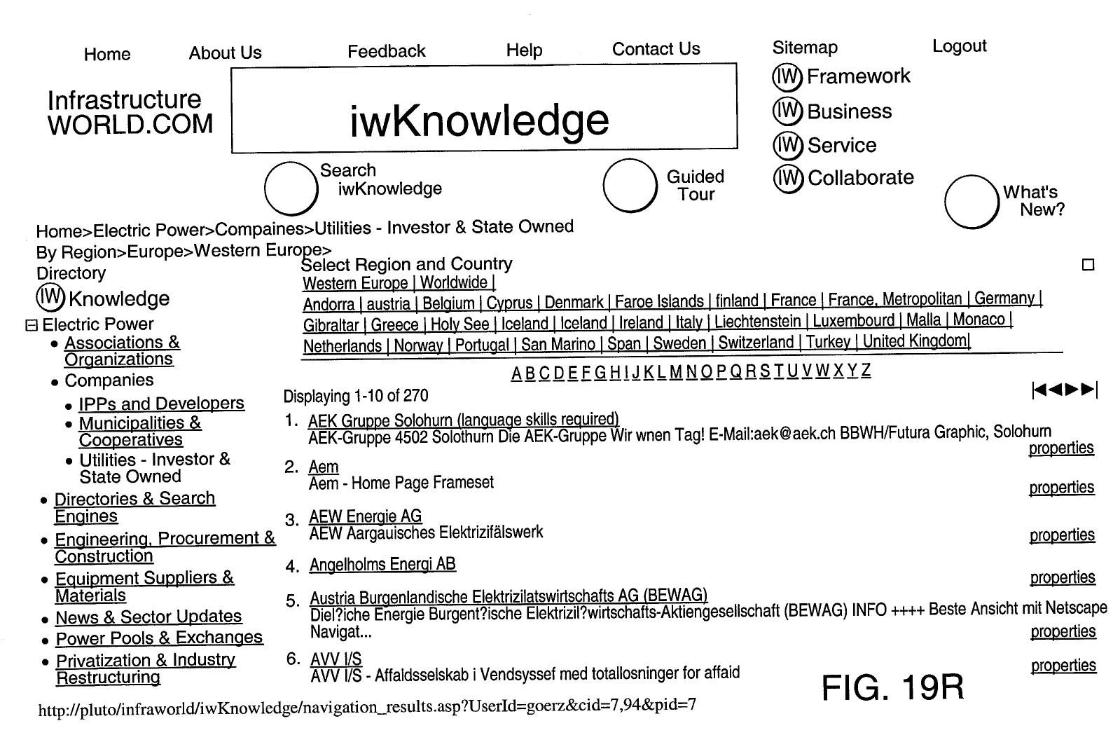

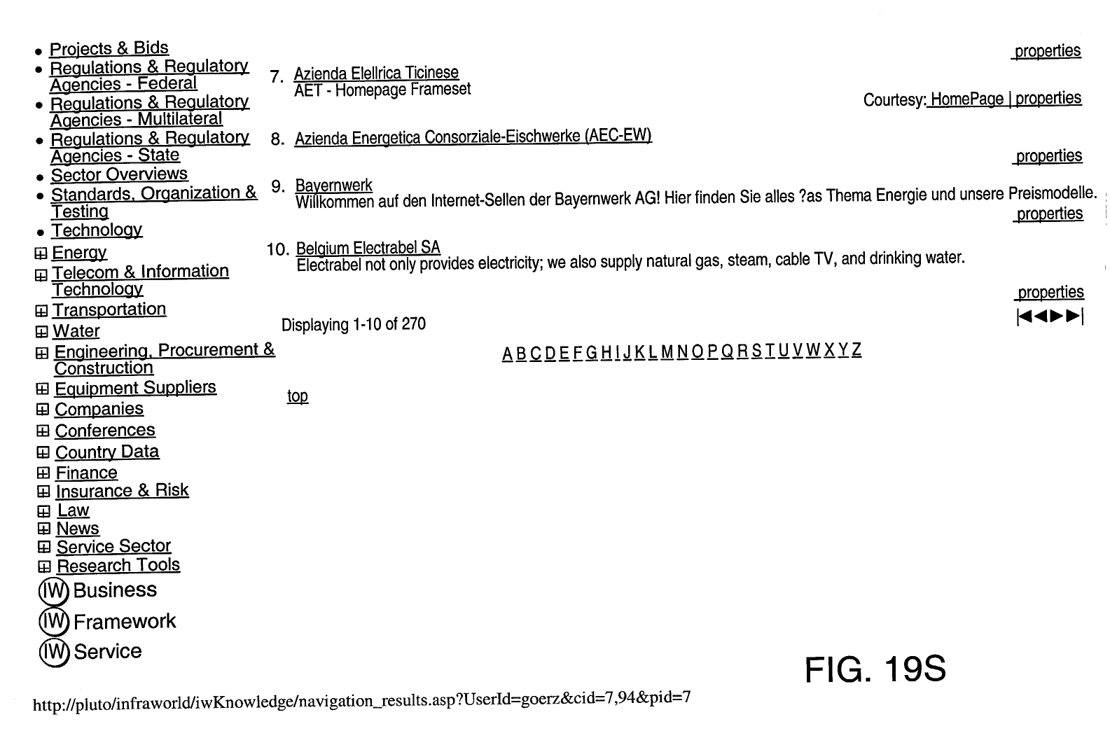

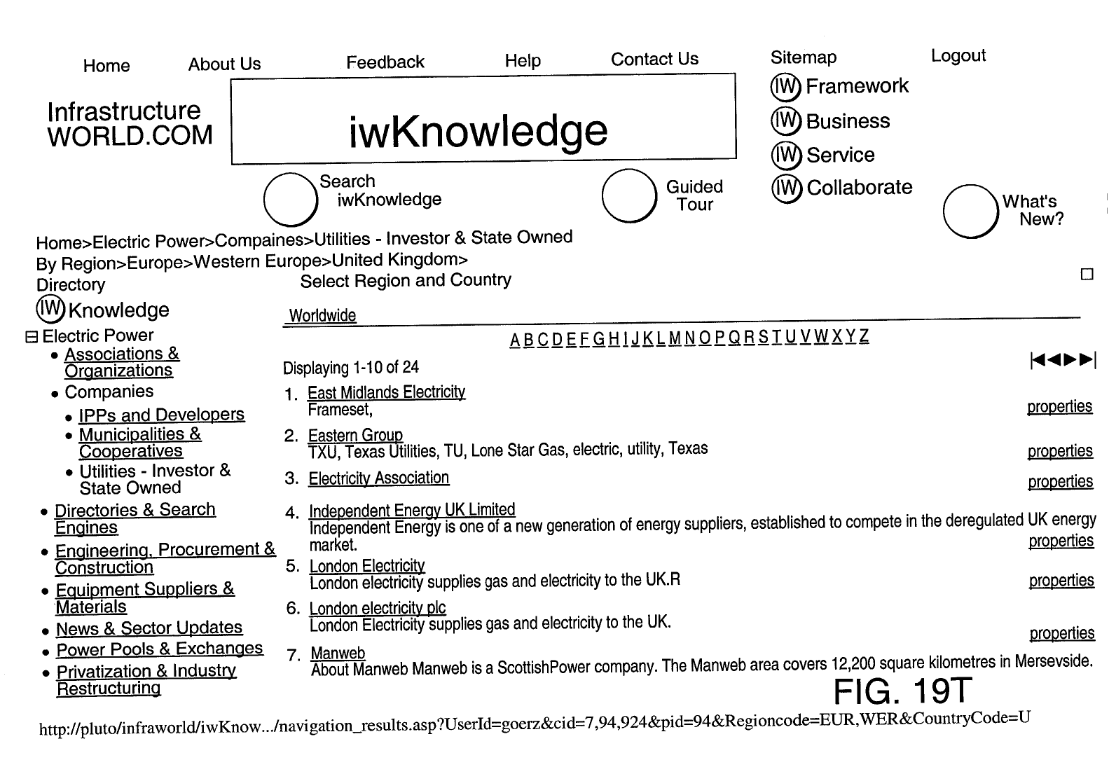

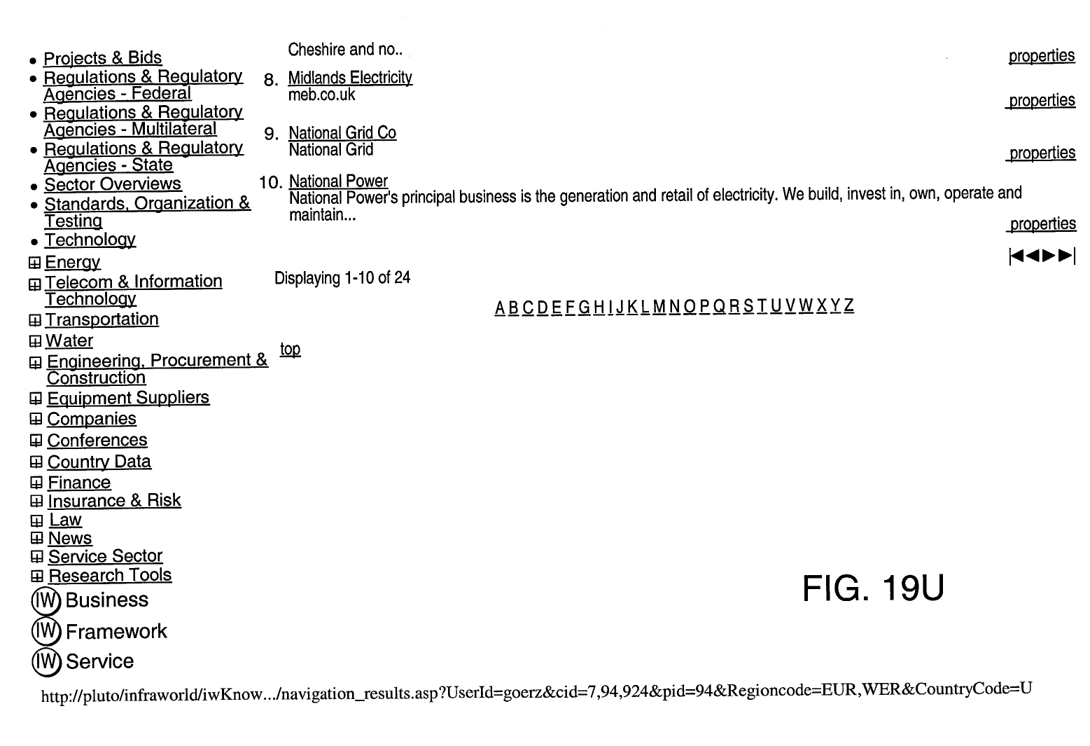

FIGS. 19A-W are screen shots highlighting the details of the service iwKnowledge, as included in an embodiment of the Website 8, where Website 8 is the Infrastructure World Website. FIGS. 19A-W illustrate the results of various navigated searches as navigated through different super categories and sub-categories in the indexed knowledge base 38.

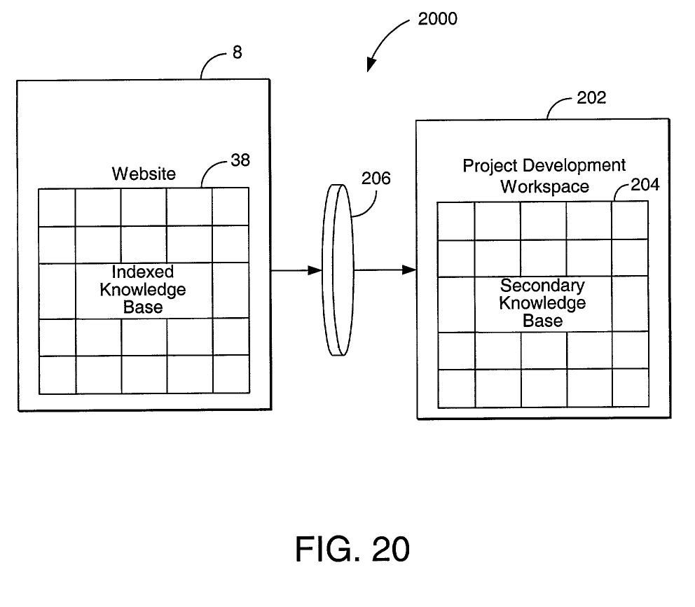

FIG. 20 is an overview of a project development workspace constructed in accordance with an embodiment of the present invention. A project development workspace is a further use of co-branding described above at FIG. 16. The same steps for creating a co-branded Website, as described in FIG. 16, may be negotiated to create a project development workspace 202. In creating a project development workspace 202, the FIG. 16 steps are accomplished focusing on a specific project.

A project development workspace 202 is a workspace for developing a particular project. Project development workspace 202 is established using a subset of information, nodes, and URLs derived from Website 8, and includes a secondary knowledge base 204, which is an indexed database, and may be initialized with a subset of the nodes from indexed knowledge base 38. The subset of nodes are potentially project related assets identified by URLs and may include project related resources, e-mail addresses, services, information, or the like. Because workspace 202 is specific to a particular project, secondary knowledge base 204 includes nodes for only those URLs representing resources and features that may pertain to that particular project.

Once established, a project development workspace may be customized according to the specific project's needs. Customization may include adding URLs, e-mail addresses, and other assets, such as resources, services, and information to secondary knowledge base 204 that are not otherwise available on Website 8, or in indexed knowledge base 38.

In an embodiment of the invention, Website 8 and indexed knowledge base 38 are unaffected when new assets or information are added to the customized project development workspace 202. In this arrangement, communications between Website 8 and project development workspace 202 are unidirectional. This unidirectional communication may be accomplished using a unidirectional data gate. One skilled in the art would be familiar with a plethora of unidirectional script, software, optical or electronic gates, such as but not limited to, a transistor, a diode, a pn junction, a programmable logic device, a software or script command structure, or the like.

In another embodiment of the invention, Website 8 and indexed knowledge base 38 are alerted when new assets or information are added to a customized project development workspace so that the assets and information may be considered for inclusion in indexed knowledge base 38.

Secondary knowledge base 204 may be further augmented or updated with Website 8 information. For example, after initializing a project development workspace 202 for a particular project, a user may find that the specific project could further benefit from information, resources, or services on Website 8 not initially identified as potentially pertaining to the specific project. In such a case, this additional Website 8 information may be added to secondary knowledge base 204 for use in project development workspace 202. Also, as new information and assets are added to Website 8, project development workspace 202 may be periodically updated with the new information and assets. In one embodiment of the invention, each time a user 15A-n accesses product development workspace 202, an Internet connection is automatically established between the workspace and Website 8. Once the connection is made, product development workspace 202 may be automatically updated with any new Website 8 potentially project related information or assets. As a further example, project development workspace 202 may be updated with new project related Website 8 information or assets on a regular time interval, or on demand.

A specific project's workspace may be completely customized for that project and, like any project using Website 8, may be organized according to a Project Life Cycle 37, using, for example, phases 48A-n to further define a project and project related resources.

A project development workspace may select among different levels of user access according to the specific project's goals and needs. For example, a specific project's project development workspace 202 may be “public” in that any Internet user may access the workspace. Similarly, it may restrict access, for example, to a company's employees, or some other defined list of persons. Restricted workspace access may be limited in any of a number of ways. For example, access to a project development workspace may be limited to users having a “key.” A “key” is discussed in the description for FIG. 2, above.

In still a further embodiment, project development workspace 202 is separate from Website 8, and there is optionally a security mechanism, such as a firewall 206 therebetween.

A project development workspace 202 is established in an allocated memory location that is separately allocated from the memory location of Website 8. The project development workspace allocated memory may reside on server 2 in server memory 6, on Internet appliance 16A-n in appliance memory 20A-n, on a client server associated with an Internet Web browser, or in another suitable computer readable memory. Workspace 202 is not coincident with Website 8.

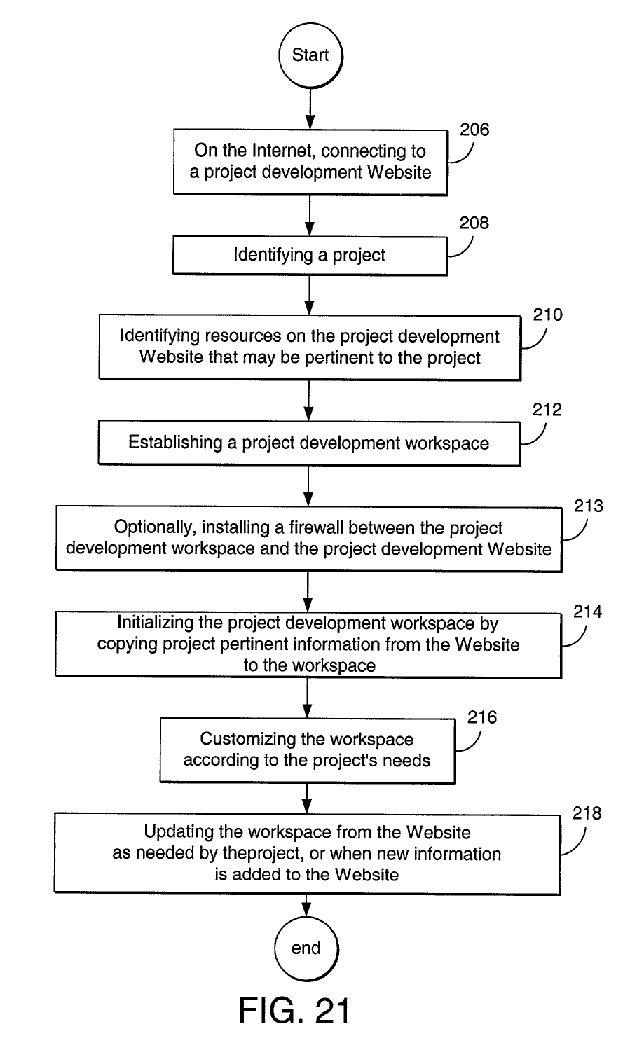

FIG. 21 is a flow diagram illustrating the steps of establishing a project development workspace 202 in accordance with an embodiment of the present invention. A project development workspace 202 may be a co-branded website, as discussed in connection with FIG. 16. In this embodiment, at step 206, a user 15A-n connects to a project development Website, such as Website 8, and at step 208, the user identifies a particular project 208 to the Website. When identifying a particular project to the Website, the user may include, for example, such information as Operating Region, Operating Country, Industry Sector, Supporting Services, Project Life Cycle including project phases, budgetary restrictions, projected deadlines, other known restrictions, or the like. Step 210 identifies potentially project related resources by making a determination of which Website information, or data, may be pertinent to the particular project. The Step 210 decision-making process may be executed in any number of ways including, but not limited to, utilizing the project related information input by the user at step 208. At step 212, a project development workspace is established, and created if it does not already exist. As above discussed, this project development workspace is not coincident with Website 8, and may be located in any number of memory locations.

Optionally, at step 213 a firewall may be installed between Website 8 and project development workspace 202. One skilled in the art would be familiar with any number of techniques and devices for installing a firewall.

At step 214, project development workspace 202 is initialized. This initialization may occur using any number of processes, including but not limited to, copying the project pertinent information from Website 8 as determined in step 210 to the project development workspace, where it may be stored in secondary knowledge base 204. At step 216, the project development workspace may be customized according to the project's needs. Here, for example, resources that are otherwise not available on Website 8, or in indexed knowledge base 38 may be included in secondary knowledge base 204. Further, at step 218, secondary knowledge base 204 may be updated as needed by the project. The updating interval may be defined according to project needs and may occur at established events or intervals, such as an automatic update each time Website 8 and indexed knowledge base 38 are updated.

The invention has been described in general terms according to embodiments of the invention. The invention is not limited to the use of URLs. Rather URLs 22 can be replaced with any block of data or identifier of a block or blocks of data on other servers or computers, or the like. Also, Indexed knowledge base 38, and secondary knowledge base 204 are each a multi-dimensional knowledge base that may include any number of dimensions, or arrangements of dimensions. Those of ordinary skill in the art will understand that certain modifications or changes may be made to the disclosed embodiment without departing from the essential nature of the invention. For example, the functions of the software executed in the software modules and/or the software described in connection with the invention could be achieved in hardware; e.g. the software's functionality could be contained in an ASIC or a programmable hardware device. The invention should therefore not be limited to the particular embodiments discussed above, but rather is defined by the claims.

We claim:

1. A project development workspace stored on a computer readable media, comprising:
a project development Website having a multi-dimensional knowledge base;
a project workspace specific to a project and associated with but distinct from said project development Website; and
a unidirectional data gate for transferring data from said project development Website to said project workspace, without influencing said contents of said project development Website.

2. The project development workspace of claim 1, wherein said multidimensional knowledge base is an indexed database that is organized according to categories and has a plurality of nodes, each said node being a URL.

3. The project development workspace of claim 2, wherein said categories are pre-defined categories selected from the group consisting of Life Cycle, Operating Region, Operating Country, Industry Sector, and Supporting Services.

4. The project development workspace of claim 2, wherein each said URL has its own attributes.

5. The project development workspace of claim 1, wherein each said data is a node represented by a URL.

6. The project development workspace of claim 5, wherein a secondary knowledge base for storing project specific data is a component of said project workspace.

7. The project development workspace of claim 6, wherein said secondary knowledge base is initialized when said project specific data is copied from said multi-dimensional knowledge to said secondary knowledge base.

8. The project development workspace of claim 7, wherein said project specific data in said secondary knowledge base is updated each time said multi-dimensional knowledge base is updated.

9. The project development workspace of claim 1, further comprising:
a user key for entering said project development Website.

10. The project development workspace of claim 9, wherein said user key includes a first user password.

11. The project development workspace of claim 1, further comprising:
a user key for entering said project workspace.

12. The project development workspace of claim 11, wherein said user key includes a user password.

13. The project development workspace of claim 1, further comprising:
a firewall between said project development Website and said project workspace.

14. A method for implementing a project development workspace, comprising the steps of:
accessing a project development Website having a multi-dimensional knowledge base;
identifying a project;
generating a project workspace specific to said project and associated with but distinct from said project development Website; and
installing a one-way data gate, allowing said project workspace to access, copy, or use the nodes of said project development Website, including said multi-dimensional knowledge base.

15. The method of claim 14, wherein said multi-dimensional knowledge base is an indexed database having a plurality of said nodes, further comprising the step of:
organizing said nodes in said indexed database according to categories, each said node being a URL; and
including in said indexed database URLs selected according to a predetermined criterion.

16. The method of claim 15, wherein said categories are selected from the group consisting of Life Cycle, Operating Region, Operating Country, Industry Sector, and Supporting Services.

17. The method of claim 15, wherein the categories include at least a Life Cycle category and a Supporting Services category.

18. The method of claim 15, wherein said project workspace includes a secondary knowledge base.

19. The method of claim 18, further comprising the step of:
organizing said secondary knowledge base by categories selected from the group consisting of Life Cycle, Operating Region, Operating Country, Industry Sector, and Supporting Services.

20. The method of claim 18, further comprising the steps of:
determining which said nodes of said multi-dimensional knowledge base are pertinent to said project;
initializing said secondary knowledge base by copying the pertinent ones of said nodes from said multi-dimensional knowledge base into said secondary knowledge base; and
customizing the contents of said secondary knowledge base according to project needs.

21. The method of claim 20, wherein said customizing step is accomplished independent of said project development Website.

22. The method of claim 21, wherein said customizing step includes adding nodes to said secondary knowledge base that are different from said nodes included in said multi-dimensional knowledge base.

23. The method of claim 14, further comprising the step of:
entering said project development Website using a first key.

24. The method of claim 23, further comprising the step of:
entering said project workspace using a second key.

25. The method of claim 24, wherein said first and second keys are a first and second user password.

26. The method of claim 14, further comprising the step of:
installing a firewall between said project workspace and said project development Website.

27. A method for implementing a project development workspace that is separate from a project development Website, but is capable of accessing, using, or copying the URLs of the project development Website for use in the project development workspace, comprising the steps of:
accessing a project development Website having a multi-dimensional indexed database with a plurality of nodes, each node being a URL selected according to a pre-determined criterion;
identifying a project;
establishing in computer memory a project workspace specific to said project, and associated with but distinct from said project development Website;
determining which said URLs in said multi-dimensional indexed database are pertinent to said project;
establishing a secondary indexed database in said computer memory as a component of said project workspace;
installing said secondary indexed database by filling it with the pertinent said URLs from said multi-dimensional indexed database; and
inserting a firewall between said project workspace and said project development Website.

28. The method of claim 27, further comprising the step of:
following the initializing step, updating said project workspace with additional said pertinent URLs at the occurrence of said multidimensional indexed database being updated, and said update includes said pertinent URLs.

29. The method of claim 27, further comprising the step of:
customizing said secondary indexed database with additional URLs, said customizing being independent of said project development Website and said multi-dimensional indexed database.

30. The method of claim 27, further comprising the step of:
organizing said secondary indexed database by categories selected from the group consisting of Life Cycle, Operating Region, Operating Country, Industry Sector, and Supporting Services.

31. A project development workspace stored on a computer readable medium comprising:
a unidirectional data gate for transferring data from a project development Website to a project development workspace without influencing the contents of said project development Website.
